(19) United States
(12) Patent Application Publication
(10) Pub. No.: US 2025/0308792 A1
(43) Pub. Date: Oct. 2, 2025

(54) MULTILAYER CERAMIC CAPACITOR

(71) Applicant: Murata Manufacturing Co., Ltd., Nagaokakyo-shi (JP)

(72) Inventor: Masatoshi YANAGIHARA, Nagaokakyo-shi (JP)

(21) Appl. No.: 19/090,619

(22) Filed: Mar. 26, 2025

(30) Foreign Application Priority Data
Mar. 28, 2024 (JP) 2024-053865

(51) Int. Cl. H01G 4/232; H01G 4/012; H01G 4/12; H01G 4/30

(52) U.S. Cl. CPC H01G 4/232; H01G 4/012; H01G 4/12; H01G 4/30

(57) ABSTRACT

A multilayer ceramic capacitor includes an inner layer portion including a capacitor effective portion in which two layers among first internal electrode layers, second internal electrode layers, and intermediate electrode layers are laminated alternately with a corresponding one of dielectric layers interposed therebetween, and a series connection region including the dielectric layers and the intermediate electrode layers alternately laminated therein. In a cross section, when a ratio of a length measured along a cross-sectional shape of an internal electrode layer to a linear distance in a length direction of an internal electrode layer is defined as an undulation amount, an undulation amount of a corresponding one of the intermediate electrode layers in the series connection region is larger than an undulation amount of each of a corresponding one of each of the first and second internal electrode layers and the intermediate electrode layers in a capacitor effective portion.

### CROSS REFERENCE TO RELATED APPLICATIONS

This application claims the benefit of priority to Japanese Patent Application No. 2024-053865 filed on Mar. 28, 2024. The entire contents of this application are hereby incorporated herein by reference.

### BACKGROUND OF THE INVENTION

### 1. Field of the Invention

The present invention relates to multilayer ceramic capacitors.

### 2. Description of the Related Art

Multilayer ceramic capacitors are sometimes required to have a high breakdown voltage. As multilayer ceramic capacitors realizing high breakdown voltage, multilayer ceramic capacitors each including a configuration in which a plurality of capacitor portions connected in series are provided, that is, multilayer ceramic capacitors each including a series configuration, have been known (refer to Japanese Unexamined Patent Application, Publication No. 2012-209495).

### SUMMARY OF THE INVENTION

In the multilayer ceramic capacitors each including such a series configuration, since the plurality of capacitor portions connected in series are provided, the capacitance decreases. In order to increase the electrostatic capacitance, it is necessary to increase the number of laminated internal electrode layers. However, when the number of laminated internal electrode layers increases, cracks or acoustic noise due to an electrostrictive effect, which is a phenomenon in which strain occurs when an electric field is applied to a dielectric, are likely to occur.

Example embodiments of the present invention provide multilayer ceramic capacitors each including a high breakdown voltage specification that are each able to reduce or prevent the occurrence of cracks or acoustic noise due to an electrostrictive effect.

An example embodiment of the present invention provides a multilayer ceramic capacitor including a multilayer body including a plurality of laminated dielectric layers and a plurality of laminated internal electrode layers, the multilayer body including a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction, a first external electrode on the first end surface, and a second external electrode on the second end surface. The plurality of internal electrode layers include first internal electrode layers, second internal electrode layers, and intermediate electrode layers. Each of the first internal electrode layers includes a first extension portion at one end thereof that extends toward the first end surface and is connected to the first external electrode, and a first counter portion that is connected to the first extension portion and is opposed to at least one corresponding internal electrode layer adjacent in the lamination direction. Each of the second internal electrode layers includes a second extension portion at one other end thereof that extends toward the second end surface and is connected to the second external electrode, and a second counter portion that is connected to the second extension portion and is opposed to at least one corresponding internal electrode layer adjacent in the lamination direction. Each of the intermediate electrode layers is not connected to the first external electrode or the second external electrode, and defines a series connection capacitor together with a corresponding one of the first internal electrode layers and a corresponding one of the second internal electrode layers. The multilayer body includes an inner layer portion including the plurality of dielectric layers and the plurality of internal electrode layers alternately laminated therein, a first lateral surface-side outer layer portion that is provided adjacent to the first lateral surface and includes only at least one of the plurality of dielectric layers laminated therein, and a second lateral surface-side outer layer portion that is provided adjacent to the second lateral surface and includes only at least one of the plurality of dielectric layers laminated therein. The inner layer portion includes an effective layer portion in which two layers among the first internal electrode layers, the second internal electrode layers, and the intermediate electrode layers are laminated alternately with a corresponding one of the plurality of dielectric layers interposed therebetween, a first end surface-side outer layer portion that is provided adjacent to the first end surface and includes the plurality of dielectric layers and the plurality of first internal electrode layers alternately laminated, a second end surface-side outer layer portion that is provided adjacent to the second end surface and includes the plurality of dielectric layers and the plurality of second internal electrode layers alternately laminated, and an intermediate gap including the plurality of dielectric layers and intermediate electrode layers alternately laminated. In a cross section parallel to the length direction and the lamination direction, when a ratio (L1/L0) of a length (L1) measured along a cross-sectional shape of an internal electrode layer in a predetermined region to a linear distance (L0) in a length direction of an internal electrode layer in a predetermined region is defined as an undulation amount, an undulation amount of a corresponding one of the intermediate electrode layers in the intermediate gap is larger than an undulation amount of each of a corresponding one of the first internal electrode layers, a corresponding one of the second internal electrode layers, and a corresponding one of the intermediate electrode layers in the effective layer portion.

According to example embodiments of the present invention, it is possible to provide multilayer ceramic capacitors each including a high breakdown voltage specification that are each able to reduce or prevent the occurrence of cracks or acoustic noise due to an electrostrictive effect.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view of a two-portion-configured multilayer ceramic capacitor according to a first example embodiment of the present invention.

FIG. 2 is a cross-sectional view along the line II-II in FIG. 1, showing a schematic configuration of a two-portion-configured multilayer body of the first example embodiment of the present invention.

FIG. 3 is a cross-sectional view along the line III-III in FIG. 2.

FIG. 4A is a cross-sectional view along the line IVA-IVA in FIG. 2, showing a cross section along a first internal electrode layer and a second internal electrode layer.

FIG. 4B is a cross-sectional view along the line IVB-IVB in FIG. 2, showing a cross section along an intermediate electrode layer.

FIG. 5 is a cross-sectional view schematically showing an intermediate electrode layer in a series connection region MG.

FIG. 6 is a schematic view for explaining a schematic configuration of a three-portion-configured multilayer ceramic capacitor including according to a second example embodiment of the present invention.

FIG. 7 is a schematic view for explaining a schematic configuration of a four-portion-configured multilayer ceramic capacitor according to a third example embodiment of the present invention.

### DETAILED DESCRIPTION OF THE EXAMPLE EMBODIMENTS

### First Example Embodiment

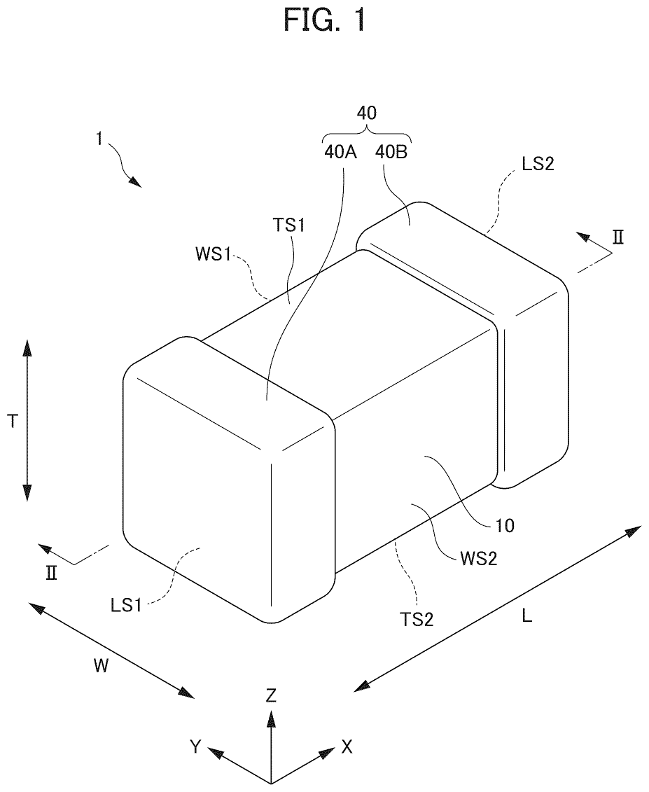

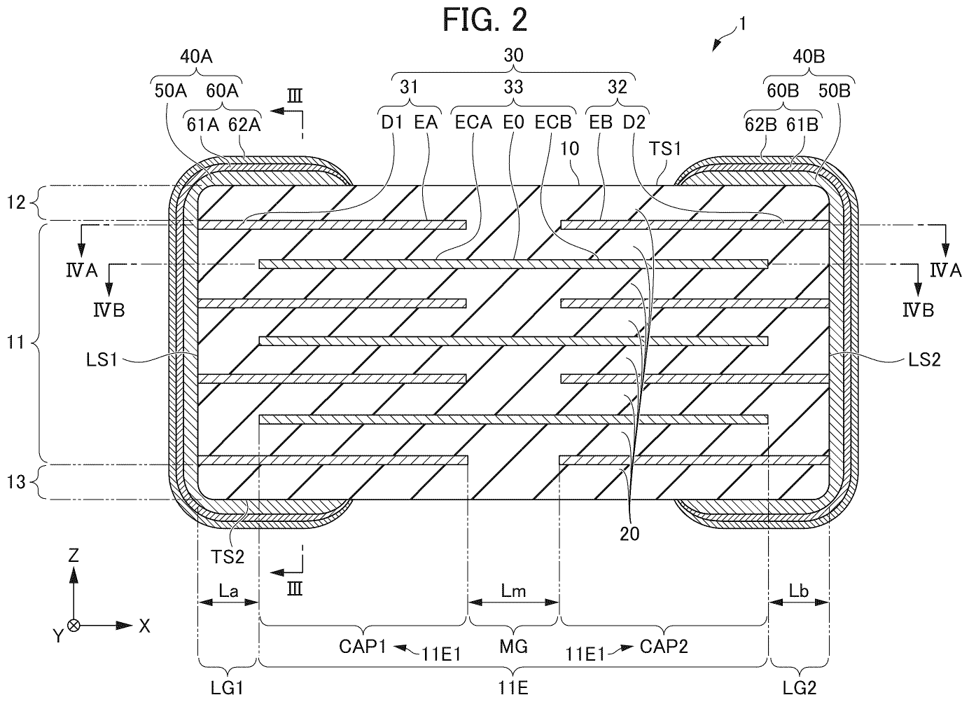

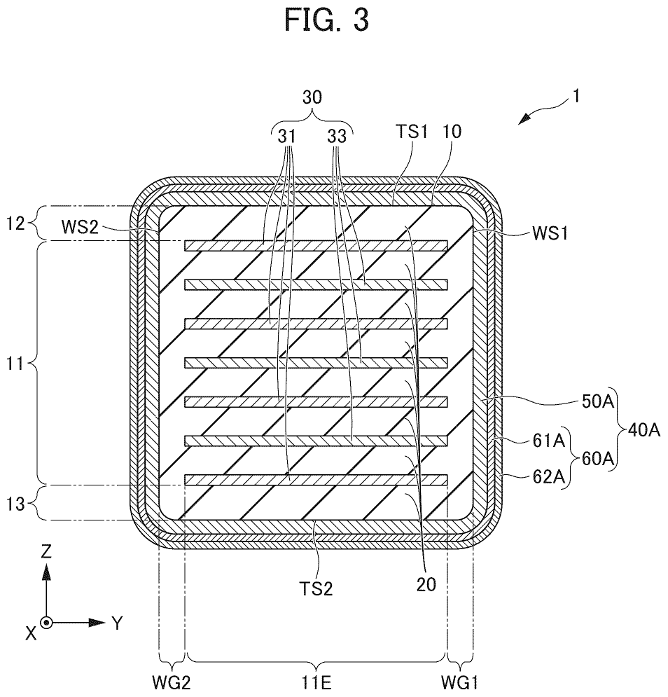

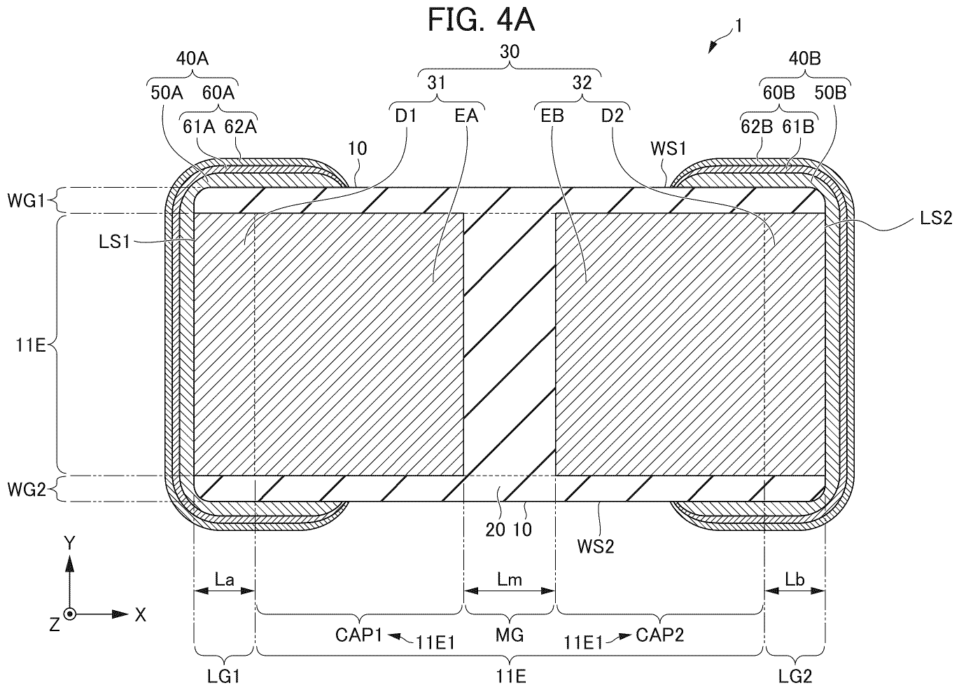

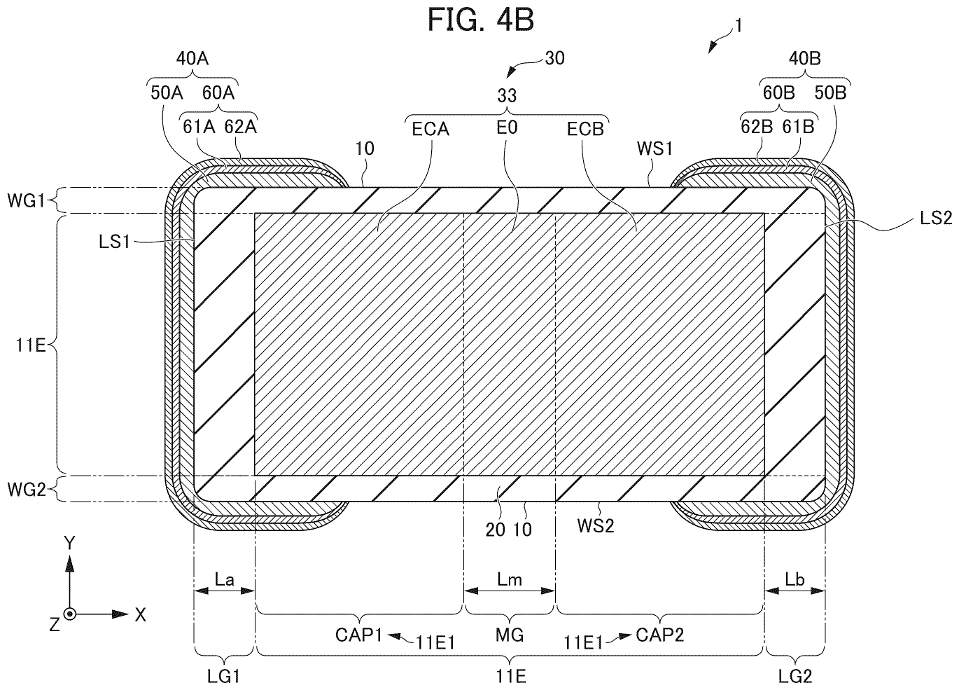

A multilayer ceramic capacitor 1 as a two-portion-configured multilayer ceramic electronic component according to a first example embodiment of the present disclosure will be described with reference to the drawings. FIG. 1 is an external perspective view of a two-portion-configured multilayer ceramic capacitor 1 according to the first example embodiment. FIG. 2 is a cross-sectional view along the line II-II in FIG. 1, showing the schematic configuration of the two-portion-configured multilayer body of the first example embodiment. FIG. 3 is a cross-sectional view along the line III-III in FIG. 2. FIG. 4A is a cross-sectional view along the line IVA-IVA in FIG. 2, showing the cross section along a first internal electrode layer and a second internal electrode layer. FIG. 4B is a cross-sectional view along the line IVB-IVB in FIG. 2, showing the cross section along an intermediate electrode layer.

The drawings are schematically simplified for the purpose of showing example embodiments of the present invention, and the proportions of the illustrated components or the ratios of dimensions between components may not match those described in the specification. Also, components described in the specification may be omitted in the drawings, or their numbers may be omitted for simplicity. For example, the number of the internal electrode layers shown in FIGS. 2 and 3 is seven for the sake of explanation, but this does not indicate the actual number of the internal electrode layers 30. Terms used in the description of example embodiments of the present invention to specify shapes, geometrical conditions, and the extent thereof, such as “parallel”, “orthogonal”, “identical”, and values of lengths and angles, are intended to be interpreted inclusively within a range that could achieve similar functionality, not limited to their strict meanings.

As shown in FIG. 1, the shape of the multilayer ceramic capacitor 1 according to an example embodiment is substantially rectangular parallelepiped. The multilayer ceramic capacitor 1 includes a substantially rectangular parallelepiped multilayer body 10 and a pair of external electrodes 40 spaced apart from each other at both ends of the multilayer body 10.

In FIG. 1, the arrow T indicates the lamination direction of the multilayer ceramic capacitor 1 and the multilayer body 10. The lamination direction T also represents the thickness direction and the height direction of the multilayer ceramic capacitor 1 and the multilayer body 10. In FIG. 1, the arrow L indicates the length direction of the multilayer ceramic capacitor 1 and the multilayer body 10, in which the length direction is orthogonal or substantially orthogonal to the lamination direction T. In FIG. 1, the arrow W indicates the width direction of the multilayer ceramic capacitor 1 and the multilayer body 10, in which the width direction is orthogonal or substantially orthogonal to both the lamination direction T and the length direction L. The pair of external electrodes 40 are provided at both ends of the multilayer body 10 in the length direction L.

FIGS. 1 to 4B illustrate an XYZ Cartesian coordinate system. The length direction L of the multilayer ceramic capacitor 1 and the multilayer body 10 corresponds to the X direction. The width direction W of the multilayer ceramic capacitor 1 and the multilayer body 10 corresponds to the Y direction. The lamination direction T of the multilayer ceramic capacitor 1 and the multilayer body 10 corresponds to the Z direction. The cross section shown in FIG. 2 is also referred to as an LT cross section. The cross section shown in FIG. 3 is also referred to as a WT cross section. The cross section shown in FIGS. 4A and 4B is also referred to as an LW cross section.

As shown in FIGS. 1 to 4B, the multilayer body 10 includes a first main surface TS1 and a second main surface TS2 on opposite sides in the lamination direction T, a first end surface LS1 and a second end surface LS2 on opposite sides in the length direction L orthogonal or substantially orthogonal to the lamination direction T, and a first lateral surface WS1 and a second lateral surface WS2 on opposite sides in the width direction W orthogonal or substantially orthogonal to both the lamination direction T and the length direction L.

As shown in FIG. 1, the shape of the multilayer body 10 is substantially rectangular parallelepiped. The dimension in the length direction L of the multilayer body 10 is not necessarily longer than the dimension in the width direction W. The corner portions and edge portions of the multilayer body 10 are preferably rounded. The corner portions are where three surfaces of the multilayer body intersect, and the edge portions are where two surfaces of the multilayer body intersect. The surfaces of the multilayer body 10 may include irregularities in whole or in part.

The dimensions of the multilayer body 10 are not particularly limited. However, the dimension of the multilayer body 10 in the length direction L, denoted as the L dimension, is preferably between about 0.2 mm and about 10 mm inclusive, for example. The dimension of the multilayer body 10 in the lamination direction T, denoted as the T dimension, is preferably between about 0.1 mm and about 10 mm inclusive, for example. The dimension of the multilayer body 10 in the width direction W, denoted as the W dimension, is preferably between about 0.1 mm and about 10 mm inclusive, for example.

As shown in FIGS. 2 and 3, the multilayer body 10 includes an inner layer portion 11, and first and second main surface-side outer layer portions 12 and 13 interposing the inner layer portion 11 in the lamination direction T.

The inner layer portion 11 includes a plurality of dielectric layers 20 and a plurality of internal electrode layers 30, both of which are laminated alternately in the lamination direction T. The inner layer portion 11 includes the internal electrode layers 30, including an internal electrode layer 30 closest to the first main surface TS1 to an internal electrode layer 30 closest to the second main surface TS2, in the lamination direction T. In the inner layer portion 11, the plurality of internal electrode layers 30 are opposed to each other interposing the dielectric layers 20. The inner layer portion 11 functions to generate capacitance, and essentially operates as a capacitor.

The plurality of dielectric layers 20 include dielectric materials. The dielectric material may be, for example, a dielectric ceramic including ingredients such as BaTiO₃, CaTiO₃, SrTiO₃, or CaZrO₃. The dielectric material include secondary components such as Mn, Fe, Cr, Co, Ni compounds added to these main components. The dielectric material is particularly preferably a material including BaTiO₃ as a main component.

The thickness of the dielectric layers 20 is preferably between about 0.2 μm and about 10 μm inclusive, for example. In particular, the thickness of the dielectric layers 20 is preferably about 3 μm and about 10 μm inclusive, for example. The number of dielectric layers 20 to be stacked (laminated) is preferably between 15 and 1200 inclusive, for example. The number of dielectric layers 20 is the total of the number of dielectric layers 20 in the inner layer portion 11, and the number of the dielectric layers 20 in the first main surface-side outer layer portion 12 and the second main surface-side outer layer portion 13.

The plurality of internal electrode layers 30 include a plurality of first internal electrode layers 31, a plurality of second internal electrode layers 32, and an intermediate electrode layer 33. The first internal electrode layers 31 and the second internal electrode layers 32 are adjacently spaced apart in the length direction L. The first and second internal electrode layers 31 and 32 and the intermediate electrode layer 33 are alternately provided in the lamination direction T interposing the dielectric layers 20 therebetween.

The first internal electrode layers 31 extend to the first end surface LS1, and are connected to a first external electrode 40A (to be described later). The second internal electrode layers 32 extend to the second end surface LS2, and are connected to a second external electrode 40B (to be described later). The intermediate electrode layer 33 does not extend to either the first end surface LS1 or the second end surface LS2, and is not connected to either the first external electrode 40A or the second external electrode 40B. The series-connected capacitors are defined by the first internal electrode layers 31, the intermediate electrode layer 33, and the second internal electrode layers 32, which are included in the plurality of internal electrode layers 30. Hereinafter, unless necessary to distinguish, the first internal electrode layers 31, the second internal electrode layers 32, and the intermediate electrode layer 33 may collectively be referred to as the internal electrode layers 30.

As shown in FIGS. 2 and 4A, the first internal electrode layer 31 includes a first counter portion EA and a first extension portion D1. The first counter portion EA is opposed to the intermediate electrode layer 33 adjacent in the lamination direction T, interposing the dielectric layer 20 therebetween, provided inside the multilayer body 10. The first internal electrode layer 31 includes the first counter portion EA that is connected to the first extension portion D1, and is opposed to another internal electrode layer 30 adjacent in the lamination direction T. The first extension portion D1 extends from the first counter portion EA to the first end surface LS1, and is exposed at the first end surface LS1. The first internal electrode layer 31 includes the first extension portion D1, one end of which extends to the first end surface LS1 and is connected to the first external electrode 40A.

As shown in FIGS. 2 and 4A, the second internal electrode layer 32 includes a second counter portion EB and a second extension portion D2. The second counter portion EB is opposed to the intermediate electrode layer 33 adjacent in the lamination direction T, interposing the dielectric layer 20 therebetween, provided inside the multilayer body 10. The second internal electrode layer 32 includes the second counter portion EB that is connected to the second extension portion D2, and is opposed to another internal electrode layer 30 adjacent in the lamination direction T. The second extension portion D2 extends from the second counter portion EB to the second end surface LS2, and is exposed at the second end surface LS2. The second internal electrode layer 32 includes the second extension portion D2, one end of which extends to the second end surface LS2 and is connected to the second external electrode 40B.

As shown in FIGS. 2 and 4B, the intermediate electrode layer 33 includes a first electrode layer-side counter portion ECA, a second electrode layer-side counter portion ECB, and a coupling portion E0. The first electrode layer-side counter portion ECA is opposed to the first internal electrode layer 31 adjacent in the lamination direction T, interposing a dielectric layer 20 therebetween, provided inside the multilayer body 10. The second electrode layer-side counter portion ECB is opposed to the second internal electrode layer 32 adjacent in the lamination direction T, interposing the dielectric layer 20 therebetween, provided inside the multilayer body 10. The coupling portion E0 couples the first electrode layer-side counter portion ECA and the second electrode layer-side counter portion ECB with each other, and is provided between the first electrode layer-side counter portion ECA and the second electrode layer-side counter portion ECB.

In the multilayer ceramic capacitor 1 according to the present example embodiment, the end portion adjacent to the first end surface LS1 of the intermediate electrode layer 33 is spaced apart from the first end surface LS1. In the multilayer ceramic capacitor 1 according to the present example embodiment, the end portion adjacent to the first end surface LS1 of the intermediate electrode layer 33 is provided adjacent to the first end surface LS1 farther than the end portion of the first external electrode 40A. However, this arrangement is not limiting. The end portion adjacent to the first end surface LS1 of the intermediate electrode layer 33 may also be provided adjacent to the second end surface LS2 farther than the end portion of the first external electrode 40A.

The end portion adjacent to the second end surface LS2 of the intermediate electrode layer 33 is spaced apart from the second end surface LS2. In the multilayer ceramic capacitor 1 according to the present example embodiment, the end portion adjacent to the second end surface LS2 of the intermediate electrode layer 33 is provided adjacent to the second end surface LS2 farther than the end portion of the second external electrode 40B. However, this arrangement is not limiting. The end portion adjacent to the second end surface LS2 of the intermediate electrode layer 33 may also be provided adjacent to the first end surface LS1 farther than the end portion of the second external electrode 40B.

As shown in FIG. 2, in the multilayer ceramic capacitor 1 according to the first example embodiment, the first internal electrode layer 31 and the second internal electrode layer 32 are provided adjacent to each other in the length direction L. In the multilayer ceramic capacitor 1 according to the first example embodiment, the first internal electrode layers 31 and the second internal electrode layers 32 are laminated alternately to overlap the intermediate electrode layer 33, interposing the dielectric layers 20.

In the present example embodiment, the first counter portion EA and the first electrode layer-side counter portion ECA are opposed to each other, interposing the dielectric layer 20, such that the capacitance CAP1 (first capacitor portion CAP1) is generated. The second counter portion EB and the second electrode layer-side counter portion ECB of the intermediate electrode layer 33, which includes the first electrode layer-side counter portion ECA, are opposed to each other, interposing the dielectric layer 20, such that the capacitance CAP2 (second capacitor portion CAP2) is generated. The coupling portion E0 connects the capacitance CAP1 and the capacitance CAP2 in series. The multilayer ceramic capacitor 1 of the present example embodiment is a two-portion-configured, i.e., series-configured multilayer ceramic capacitor 1, in which two capacitor portions are connected in series.

The shapes of the first counter portion EA, the second counter portion EB, the first electrode layer-side counter portion ECA, and the second electrode layer-side counter portion ECB are not particularly limited but are preferably rectangular. However, the corner portions of the rectangular shape may be rounded or diagonal. The shapes of the first extension portion D1 and the second extension portion D2 are not particularly limited but are preferably rectangular. Again, the corner portions of the rectangular shape may be rounded or diagonal. The shape of the coupling portion E0 is not particularly limited but is preferably rectangular.

The dimensions of the first counter portion EA and the first extension portion D1 in the width direction W may be the same or substantially same, or either one of the dimensions may be smaller. The dimensions of the second counter portion EB and the second extension portion D2 in the width direction W may be the same or substantially same, or either one of the dimensions may be smaller. The dimensions of the first and second electrode layer-side counter portions ECA and ECB and the coupling portion E0 in the width direction W may be the same or substantially same, or either one of the dimensions may be smaller.

The first internal electrode layer 31, the second internal electrode layer 32, and the intermediate electrode layer 33 may be made of suitable electrically conductive materials such as metals including Ni, Cu, Ag, Pd, Au, or alloys including at least one of these metals. When alloys are used, the first internal electrode layer 31, the second internal electrode layer 32, and the intermediate electrode layer 33 may be made of, for example, an Ag—Pd alloy.

The thickness of the first internal electrode layer 31, the second internal electrode layer 32, and the intermediate electrode layer 33 is preferably between about 0.2 μm and about 2.0 μm inclusive, for example. The total number of the first internal electrode layer 31, the second internal electrode layer 32, and the intermediate electrode layer 33 combined is preferably between 15 and 1000 inclusive, for example.

As shown in FIGS. 2 and 3, the first main surface-side outer layer portion 12 is provided adjacent to the first main surface TS1 of the multilayer body 10. The first main surface-side outer layer portion 12 is a collective portion including the plurality of dielectric layers 20 between the first main surface TS1 and the internal electrode layer 30 closest to the first main surface TS1. On the other hand, the second main surface-side outer layer portion 13 is provided adjacent to the second main surface TS2 of the multilayer body 10. The second main surface-side outer layer portion 13 is a collective portion including the plurality of dielectric layers 20 between the second main surface TS2 and the internal electrode layer 30 closest to the second main surface TS2. The dielectric layers 20 used for the first main surface-side outer layer portion 12 and the second main surface-side outer layer portion 13 may be the same as the dielectric layers 20 used for the inner layer portion 11.

The multilayer body 10 includes a series capacitor defining portion 11E. The series capacitor defining portion 11E includes a portion where the first counter portion EA of the first internal electrode layer 31 is opposed to the first electrode layer-side counter portion ECA of the intermediate electrode layer 33 (portion generating the capacitance CAP1), a portion where the second counter portion EB of the second internal electrode layer 32 is opposed to the second electrode layer-side counter portion ECB of the intermediate electrode layer 33 (portion generating the capacitance CAP2), and a portion connecting the capacitance CAP1 and the capacitance CAP2 with each other in series. The series capacitor defining portion 11E is a portion of the inner layer portion 11. FIGS. 4A and 4B show the range of the series capacitor defining portion 11E in the width direction W and the length direction L. The portions of the series capacitor defining portion 11E, which generate the capacitance CAP1 (first capacitor portion CAP1) and capacitance CAP2 (second capacitor portion CAP2), are also referred to as capacitor effective portions 11E1 or effective layer portions 11E1.

The multilayer body 10 includes lateral surface-side outer layer portions. The lateral surface-side outer layer portions include a first lateral surface-side outer layer portion WG1 and a second lateral surface-side outer layer portion WG2. The first lateral surface-side outer layer portion WG1 is a portion including the dielectric layers 20 between the series capacitor defining portion 11E and the first lateral surface WS1. The second lateral surface-side outer layer portion WG2 is a portion including the dielectric layers 20 between the series capacitor defining portion 11E and the second lateral surface WS2. FIGS. 3, 4A, and 4B show the range of the first lateral surface-side outer layer portion WG1 and the second lateral surface-side outer layer portion WG2 in the width direction W. These lateral surface-side outer layer portions are also referred to as W gaps or side gaps.

The multilayer body 10 includes end surface-side outer layer portions. The end surface-side outer layer portions include a first end surface-side outer layer portion LG1 and a second end surface-side outer layer portion LG2. The first end surface-side outer layer portion LG1 is a portion including the dielectric layers 20 and the first extension portion D1, provided between the series capacitor defining portion 11E and the first end surface LS1. In other words, the first end surface-side outer layer portion LG1 is a collective portion including a portion of the plurality of dielectric layers 20 adjacent to the first end surface LS1 and the plurality of first extension portions D1. The second end surface-side outer layer portion LG2 is a portion including the dielectric layers 20 and the second extension portion D2, provided between the series capacitor defining portion 11E and the second end surface LS2. In other words, the second end surface-side outer layer portion LG2 is a collective portion including a portion of the plurality of dielectric layers 20 adjacent to the second end surface LS2 and the plurality of second extension portions D2. FIGS. 2, 4A, and 4B show the range of the first end surface-side outer layer portion LG1 and the second end surface-side outer layer portion LG2 in the length direction L. The end surface-side outer layer portions are also referred to as L-gaps or end gaps.

The series capacitor defining portion 11E of the multilayer body 10 includes a series connection region MG. The series connection region MG is a portion including the dielectric layer 20 and the coupling portion E0, which are provided between the portion generating the capacitance CAP1 and the portion generating the capacitance CAP2. In other words, the series connection region MG is a collective portion including the middle portion of the plurality of dielectric layers 20 in the length direction L, and the plurality of coupling portions E0. The series connection region MG is also referred to as an intermediate gap MG.

As shown in FIGS. 1 and 2, the external electrodes 40 include the first external electrode 40A adjacent to the first end surface LS1 of the multilayer body 10, and the second external electrode 40B adjacent to the second end surface LS2 of the multilayer body 10.

The basic configurations of the first external electrode 40A and the second external electrode 40B are the same or substantially same. The shape of the first external electrode 40A and the second external electrode 40B is generally plane-symmetrical with respect to the WT cross section in the middle of the multilayer ceramic capacitor 1 in the length direction L. Therefore, unless necessary to distinguish, the first external electrode 40A and the second external electrode 40B may collectively be referred to as the external electrodes 40.

The first external electrode 40A is provided on the first end surface LS1. The first external electrode 40A is in contact with the first extension portions D1 of the plurality of first internal electrode layers 31 exposed at the first end surface LS1. Consequently, the first external electrode 40A is electrically connected to the plurality of first internal electrode layers 31. The first external electrode 40A may also be provided on a portion of the first main surface TS1, a portion of the second main surface TS2, a portion of the first lateral surface WS1, and a portion of the second lateral surface WS2. In the present example embodiment, the first external electrode 40A extends from the first end surface LS1 to a portion of the first main surface TS1, a portion of the second main surface TS2, a portion of the first lateral surface WS1, and a portion of the second lateral surface WS2.

The second external electrode 40B is provided on the second end surface LS2. The second external electrode 40B is in contact with each of the second extension portions D2 of the plurality of second internal electrode layers 32 exposed at the second end surface LS2. Consequently, the second external electrode 40B is electrically connected to the plurality of second internal electrode layers 32. The second external electrode 40B may be provided on a portion of the first main surface TS1, a portion of the second main surface TS2, a portion of the first lateral surface WS1, and a portion of the second lateral surface WS2. In the present example embodiment, the second external electrode 40B extends from the second end surface LS2 to a portion of the first main surface TS1, a portion of the second main surface TS2, a portion of the first lateral surface WS1, and a portion of the second lateral surface WS2.

As previously mentioned, within the multilayer body 10, the first counter portion EA of the first internal electrode layer 31 is opposed to the first electrode layer-side counter portion ECA of the intermediate electrode layer 33, interposing the dielectric layer 20, such that the capacitance CAP1 (first capacitor portion CAP1) is generated. The second counter portion EB of the second internal electrode layer 32 is opposed to the second electrode layer-side counter portion the ECB of intermediate electrode layer 33, interposing the dielectric layer 20, such that the capacitance CAP2 (the second capacitor portion CAP2) is generated.

The coupling portion E0 connects the capacitance CAP1 and the capacitance CAP2 in series. Therefore, capacitor characteristics of the series-connected capacitance exhibit between the first external electrode 40A connected to the first internal electrode layer 31 and the second external electrode 40B connected to the second internal electrode layer 32.

As shown in FIG. 2, the first external electrode 40A includes a first base electrode layer 50A, and a first plated layer 60A on the first base electrode layer 50A. Similarly, the second external electrode 40B includes a second base electrode layer 50B, and a second plated layer 60B on the second base electrode layer 50B.

The first base electrode layer 50A is provided on the first end surface LS1. The first base electrode layer 50A is connected to the first extension portions D1 of the plurality of first internal electrode layers 31 exposed at the first end surface LS1. In the present example embodiment, the first base electrode layer 50A extends from the first end surface LS1 to a portion of the first main surface TS1, a portion of the second main surface TS2, a portion of the first lateral surface WS1, and a portion of the second lateral surface WS2.

The second base electrode layer 50B is provided on the second end surface LS2. The second base electrode layer 50B is in contact with the second extension portions D2 of the plurality of second internal electrode layers 32 exposed at the second end surface LS2. In the present example embodiment, the second base electrode layer 50B extends from the second end surface LS2 to a portion of the first main surface TS1, a portion of the second main surface TS2, a portion of the first lateral surface WS1, and a portion of the second lateral surface WS2.

The first base electrode layer 50A and the second first base electrode layer 50B include at least one selected from a fired layer, a thin film layer, etc.

The first base electrode layer 50A and the second base electrode layer 50B of the present example embodiment are fired layers. The fired layer preferably includes a metal component and either a glass component or a ceramic component, or both. The metal component may include, for example, at least one of Cu, Ni, Ag, Pd, Ag—Pd alloy, or Au. The glass component may include, for example, at least one of B, Si, Ba, Mg, Al, or Li. The ceramic component may use the same ceramic material as the dielectric layer 20 or a different type of ceramic material. The ceramic component includes, for example, at least one selected from BaTiO₃, CaTiO₃, (Ba, Ca) TiO₃, SrTiO₃, CaZrO₃, and the like.

The fired layer is formed by applying an electrically conductive paste including glass and metal to the multilayer body 10, followed by: firing. The fired layer can be formed by simultaneously firing a pre-firing multilayer chip, which is a material of the multilayer body 10 including the plurality of internal electrode layers and dielectric layers, and the electrically conductive paste applied to the multilayer chip. Alternatively, the fired layer can be formed by obtaining the multilayer body 10 by firing the multilayer chip and then applying the electrically conductive paste to the multilayer body 10, followed by firing. In the case as described above, the fired layer is preferably formed by firing a mixture including ceramic material instead of a glass component. In this case, as the ceramic material to be added, using a ceramic material similar to the dielectric layer 20 is particularly preferable. The fired layer may include a plurality of layers.

The thickness of the first base electrode layer 50A provided on the first end surface LS1 in the length direction L is, for example, preferably between about 3 μm and about 200 μm inclusive in the middle of the first base electrode layer 50A in the lamination direction T and the width direction W, for example.

The thickness of the second base electrode layer 50B provided on the second end surface LS2 in the length direction L is, for example, preferably between about 3 μm and about 200 μm inclusive in the middle of the second base electrode layer 50B in the lamination direction T and the width direction W, for example.

In cases where the first base electrode layer 50A is also provided on a portion of at least one of the first main surface TS1 or the second main surface TS2, the thickness of the first base electrode layer 50A provided in this portion in the lamination direction T is, for example, preferably between about 3 μm and about 25 μm inclusive in the middle of the first base electrode layer 50A provided in this portion in the length direction L and the width direction W, for example.

In cases where the first base electrode layer 50A is also provided on a portion of at least one of the first lateral surface WS1 or the second lateral surface WS2, the thickness of the first base electrode layer 50A provided in this portion in the width direction W is, for example, preferably between about 3 μm and about 25 μm inclusive in the middle of the first base electrode layer 50A provided in this portion in the length direction L and the lamination direction T, for example.

In cases where the second base electrode layer 50B is also provided on a portion of at least one of the first main surface TS1 or the second main surface TS2, the thickness of the second base electrode layer 50B provided in this portion in the lamination direction T is, for example, preferably between about 3 μm and about 25 μm inclusive in the middle of the second base electrode layer 50B provided in this portion in the length direction L and the width direction W, for example.

In cases where the second base electrode layer 50B is also provided on a portion of at least one of the first lateral surface WS1 or the second lateral surface WS2, the thickness of the second base electrode layer 50B provided in this portion in the width direction W is, for example, preferably between about 3 μm and about 25 μm inclusive in the middle of the second base electrode layer 50B provided in this portion in the length direction L and the lamination direction T, for example.

In the present example embodiment, the first base electrode layer 50A and the second base electrode layer 50B may be thin film layers. A thin film layer is a layer of accumulated metal particles.

The first base electrode layer 50A and the second base electrode layer 50B, when formed as thin film layers, are preferably formed using a thin film formation method such as a sputtering or vapor deposition method. Here, sputtered electrodes formed by the sputtering method are described.

The first base electrode layer 50A of the present example embodiment may include a first thin film layer including a sputtered electrode. The second base electrode layer 50B may include a second thin film layer including a sputtered electrode. When forming the base electrode layer with the sputtered electrode, the sputtered electrode is preferably directly formed on at least a portion of either the first main surface TS1 or the second main surface TS2 of the multilayer body 10. The first thin film layer formed of the sputtered electrode is provided on a portion of the first main surface TS1 adjacent to the first lateral surface WS1. The second thin film layer formed of the sputtered electrode is provided on a portion of the first main surface TS1 adjacent to the second lateral surface WS2.

The thin film layer formed of the sputtering electrode preferably includes at least one type of metal selected from a group consisting of Mg, Al, Ti, W, Cr, Cu, Ni, Ag, Co, Mo, and V. As a result, the strength of fixing the external electrodes 40 to the multilayer body 10 can be enhanced. The thin film layer may include a single layer or a plurality of layers. For example, the thin film layer may include a two-layer configuration including a Ni—Cr alloy layer and a Ni—Cu alloy layer.

The first plated layer 60A is provided to cover the first base electrode layer 50A.

The second plated layer 60B is provided to cover the second base electrode layer 50B.

The first plated layer 60A and the second plated layer 60B may include at least one selected from Cu, Ni, Sn, Ag, Pd, Ag—Pd alloy, or Au. The first plated layer 60A and the second plated layer 60B may include a plurality of layers. The first plated layer 60A and the second plated layer 60B preferably include a two-layer configuration in which a Sn plated layer is formed on top of a Ni plated layer.

In the present example embodiment, the first plated layer 60A includes a first Ni plated layer 61A, and a first Sn plated layer 62A on the first Ni plated layer 61A.

In the present example embodiment, the second plated layer 60B includes a second Ni plated layer 61B, and a second Sn plated layer 62B on the second Ni plated layer 61B.

The Ni plated layer prevents the first base electrode layer 50A and the second base electrode layer 50B from being eroded by solder when mounting the multilayer ceramic capacitor 1. The Sn plated layer improves the wettability of solder when mounting the multilayer ceramic capacitor 1. As a result, the multilayer ceramic capacitor 1 can be easily mounted. The thickness of the first Ni plated layer 61A, the first Sn plated layer 62A, the second Ni plated layer 61B, and the second Sn plated layer 62B is preferably between about 2 μm and about 10 μm inclusive, for example.

The external electrodes 40 of the present example embodiment may include an electrically conductive resin layer including electrically conductive particles and thermosetting resin. The electrically conductive resin layer may be provided to cover the fired layer. In the case where the electrically conductive resin layer covers the fired layer, the electrically conductive resin layer is provided between the fired layer and the plated layers (the first plated layer 60A, the second plated layer 60B). The electrically conductive resin layer may completely cover the fired layer or partly cover the fired layer.

An electrically conductive resin layer including thermosetting resin is more flexible than an electrically conductive layer formed from a plating film or a fired electrically conductive paste. Therefore, the electrically conductive resin layer functions as a cushioning layer, even if the multilayer ceramic capacitor 1 is subjected to physical shock or thermal-cycling shock. Therefore, the electrically conductive resin layer reduces or prevents the occurrence of cracks in the multilayer ceramic capacitor 1.

The metals of the electrically conductive particles may be Ag, Cu, Ni, Sn, Bi, or alloys including them. The electrically conductive particles preferably include Ag (silver). The electrically conductive particles are, for example, metallic powder of Ag. Ag has the lowest specific resistance among metals, thus suitable as an electrode material. Ag being a noble metal is resistant to oxidation and has high weather resistance. Therefore, metallic powder of Ag is suitable as conductive particles.

The electrically conductive particles may be metal powders coated with Ag on the surfaces thereof. When using a metal powder coated with Ag, the metal powder is preferably Cu, Ni, Sn, Bi, or their alloy powder. Ag-coated metal powders are preferably used in order to maintain the properties of Ag while controlling the cost of base metal.

The electrically conductive particles may be Cu or Ni subjected to antioxidant treatment. The electrically conductive particles may be metal powder coated with Sn, Ni, Cu on the surfaces thereof. When using metal powder coated with Sn, Ni, Cu, the metal powder is preferably Ag, Cu, Ni, Sn, Bi, or their alloy powders.

The shape of the electrically conductive particles is not particularly limited. Electrically conductive particles can be of various shapes, including spherical and flat shapes, but it is preferable to use a mixture of spherical metal powders and flat metal powders.

The electrically conductive particles in the electrically conductive resin layer primarily serve to ensure the electric conductivity of the electrically conductive resin layer. Specifically, a plurality of electrically conductive particles contacting each other define electrically conductive pathways within the electrically conductive resin layer.

The resin of the electrically conductive resin layer may include at least one selected from various known thermosetting resins, such as epoxy resin, phenolic resin, urethane resin, silicone resin, polyimide resin, among others. Among these, epoxy resin, known for its excellent heat resistance, moisture resistance, and adhesiveness, is one of the most suitable resins. The resin of the electrically conductive resin layer preferably includes a curing agent along with the thermosetting resin. When using epoxy resin as the base resin, the curing agent for epoxy resin may be one of various known compounds, such as phenolic, amine, anhydride, imidazole, active ester, or amid-imide type.

The electrically conductive resin layer may include a plurality of layers. The thickest portion of the electrically conductive resin layer is preferably between about 10 μm and about 150 μm inclusive, for example.

The first plated layer 60A and the second plated layer 60B may be directly provided on the multilayer body 10, instead of providing the first base electrode layer 50A and the second base electrode layer 50B. In other words, the multilayer ceramic capacitor 1 may include plated layers directly electrically connected to the first internal electrode layer 31 and the second internal electrode layer 32. In such cases, a catalyst may be applied to the surface of the multilayer body 10 as a pretreatment, followed by forming the plated layers.

Even in this case, the plated layers are preferably a plurality of layers. The base plated layers and the top plated layers may each include at least one type of metal or alloy selected from, for example, Cu, Ni, Sn, Pb, Au, Ag, Pd, Bi, or Zn. The base plated layer is more preferably formed using Ni, which has solder barrier properties. The top plated layer is more preferably formed using Sn or Au, known for good solder wettability. For instance, when the first internal electrode layer 31 and the second internal electrode layer 32 are formed using Ni, the base plated layer is preferably formed using Cu, which bonds well with Ni. The top plated layer may be formed as needed, and the external electrodes 40 may consist solely of the base plated layers. The plated layer may include the top plated layer as the outermost layer, or may further include another plated layer on the surface of the top plated layer.

The thickness of each of the plated layers, when provided without a base electrode layer, is preferably between about 2 μm and about 10 μm inclusive, for example. The plated layer preferably does not contain glass. The metal ratio per unit volume of the plated layer is preferably about 99 volume % or higher, for example.

Direct formation of the plated layer on the multilayer body 10 can reduce the thickness of the base electrode layer. Thus, reducing the thickness of the base electrode layer allows for a reduction in the dimension of the multilayer ceramic capacitor 1 in the lamination direction T, allowing for shortening the height of the multilayer ceramic capacitor 1. Alternatively, the reduction in the thickness of the base electrode layer allows for an increase in the thickness of the dielectric layer 20 interposed between the first internal electrode layer 31, the second internal electrode layer 32, and the intermediate electrode layer 33, improving the body thickness. As such, direct formation of the plated layer on the multilayer body 10 enhances the design flexibility of the multilayer ceramic capacitor.

The basic configuration of the multilayer ceramic capacitor 1 according to the present example embodiment has been described above. The dimension of the multilayer ceramic capacitor 1 including the multilayer body 10 and the external electrodes 40 in the length direction, referred to as the L dimension, is preferably between about 0.2 mm and about 10 mm inclusive, for example. The dimension of the multilayer ceramic capacitor 1 in the lamination direction, referred to as the T dimension, is preferably between about 0.1 mm and about 10 mm inclusive, for example. The dimension of the multilayer ceramic capacitor 1 in the width direction, referred to as the W dimension, is preferably between about 0.1 mm and about 10 mm inclusive, for example.

Next, the internal electrode layers 30 of the present example embodiment will be described in detail with reference to FIGS. 1 to 5.

In the multilayer ceramic capacitor 1 of the present example embodiment, in the cross section (LT cross section) in a plane parallel to the length direction L and the lamination direction T, the undulation amount of one of the intermediate electrode layers 33 in the series connection region MG, which is also referred to as the intermediate gap MG, is larger than the undulation amount of one of the first internal electrode layers 31, one of the second internal electrode layers 32, or one of the intermediate electrode layers 33 in the capacitor effective portion 11E1, which is also referred to as the effective layer portion 11E1.

Here, the undulation amount is defined as a ratio (L1/L0) of the length L1 measured along the cross-sectional shape of the internal electrode layer 30 in the predetermined region to the linear distance L0 in the length direction L of the internal electrode layer 30 in the predetermined region. In addition, the predetermined region for calculating the undulation amount of the intermediate electrode layer 33 in the series connection region MG refers to the region of the series connection region MG, and the predetermined region for calculating the undulation amount of the first internal electrode layer 31, the second internal electrode layer 32, or the intermediate electrode layer 33 in the capacitor effective portion 11E1 refers to the region of the corresponding capacitor effective portion 11E1.

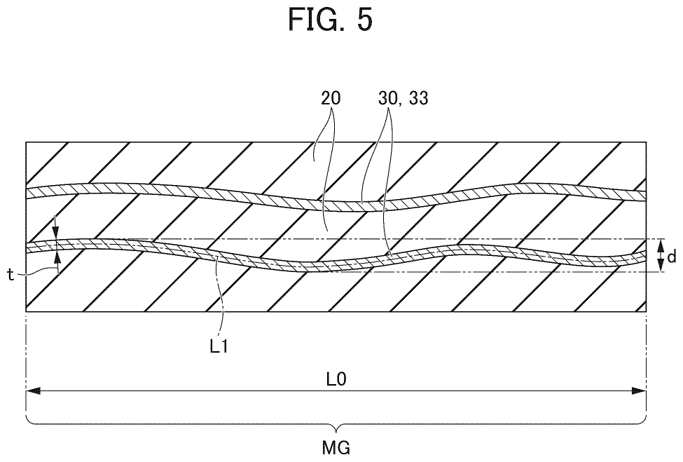

FIG. 5 shows an example of the internal electrode layer 30, and is an LT cross-sectional view schematically showing the intermediate electrode layer 33 as the internal electrode layer 30 in the series connection region MG.

As shown in FIG. 5, the internal electrode layer 30 of the present example embodiment has a wavy shape and has undulations. The internal electrode layer 30 has undulations and is present over a range of the distance d in the lamination direction. For example, the distance d may be two or more times the thickness t of the internal electrode layer 30.

FIG. 5 shows the linear distance L0 in the length direction L of the intermediate electrode layer 33 as the internal electrode layer 30 in the series connection region MG as the predetermined region. Further, FIG. 5 shows the length L1 measured along the cross-sectional shape of the intermediate electrode layer 33 as the internal electrode layer 30 in the series connection region MG as the predetermined region. The undulation amount of the intermediate electrode layer 33 in the series connection region MG is calculated by the ratio (L1/L0) of the length L1 to the linear distance L0. The undulation amount of each of the first internal electrode layer 31, the second internal electrode layer 32, and the intermediate electrode layer 33 in the capacitor effective portion 11E1 are also calculated by the same method.

The undulation amount of the intermediate electrode layer 33 in the series connection region MG is preferably about 100.1% or more and about 100.8% or less, for example. The undulation amount of the first internal electrode layer 31, the second internal electrode layer 32, or the intermediate electrode layer 33 in the capacitor effective portion 11E1 is preferably greater than about 100.0% and less than or equal to about 100.5%, for example.

As described above, a high permittivity material is used for the dielectric layer 20 of the multilayer ceramic capacitor 1, and when a voltage is applied between the external electrodes 40 of the multilayer ceramic capacitor 1, an electrostrictive effect is generated that causes deformation in which the dielectric layer 20 expands in the electric field direction and contracts in a direction perpendicular to the electric field direction. In this case, the amount of deformation due to the electrostrictive effect increases as the number of the internal electrode layers 30 increases. In the series configuration, since the amount of deformation due to the electrostrictive effect becomes larger because the number of the internal electrode layers 30 is larger than that in the normal configuration, there is more concern about the occurrence of cracks and acoustic noise.

In the present example embodiment, the undulation amount of the intermediate electrode layer 33 in the series connection region MG is larger than the undulation amount of the first internal electrode layer 31, the second internal electrode layer 32, or the intermediate electrode layer 33 in the capacitor effective portion 11E1. Since the internal electrode layer 30 in which an electric field is generated when a voltage is applied between the external electrodes 40 of the multilayer ceramic capacitor 1 has undulation, it is possible to shift the local electric field direction in the vicinity of the surface of the internal electrode layer 30. In particular, by shifting the electric field direction in a region near the middle in the length direction L of the multilayer body in which the force of delamination is likely to act due to the electrostrictive effect, it is possible to cancel or weaken the strain due to the electrostrictive effect in the adjacent regions.

Therefore, it is possible to reduce or prevent the influence of strain due to the electrostrictive effect in the entire dielectric layer 20, and thus it is possible to obtain an advantageous effect of reducing or preventing cracks and acoustic noise due to the electrostriction. In addition, when the undulation of the internal electrode layer 30 is too large, a portion in which the dielectric layer may locally thin occurs, the insulation resistance may decrease, such that the high-temperature load life cannot be ensured in some cases. Therefore, the undulation amount of the intermediate electrode layer 33 in the series connection region MG is preferably about 100.1% or more and about 100.8% or less, and the undulation amount of the first internal electrode layer 31, the second internal electrode layer 32, or the intermediate electrode layer 33 in the capacitor effective portion 11E1 is preferably more than about 100.0% and less than or equal to about 100.5%, for example. As compared with the series connection region MG, the capacitor effective portion 11E1 undergoes a larger influence when the undulation is excessively large, and a portion where the dielectric layer is locally thinned is likely to occur. Therefore, the undulation amount of the first internal electrode layer 31, the second internal electrode layer 32, or the intermediate electrode layer 33 in the capacitor effective portion 11E1 is preferably smaller than the undulation amount of the intermediate electrode layer 33 in the series connection region MG.

The distance Lm in the length direction L of the series connection region MG in which the portion of the internal electrode layer 30 having a larger undulation amount than the internal electrode layer 30 in the capacitor effective portion 11E1 is provided may be longer than the distance La in the length direction L of the first end surface-side outer layer portion LG1 and the distance Lb in the length direction L of the second end surface-side outer layer portion LG2.

Hereinafter, a non-limiting example of a method of measuring the undulation amount will be described.

First, the multilayer ceramic capacitor 1 is polished from the first lateral surface WS1 or the second lateral surface WS2 to expose the LT cross section where the series capacitor defining portion 11E of the multilayer body 10 is exposed. If necessary, the exposed LT cross section as the observation position is etched to remove the internal electrode layer 30 stretched by polishing. In the LT cross section in the middle portion in the width direction W, measurement points M1 to M6 to be described later are observed using an optical microscope.

The measurement points are set in the capacitor effective portion 11E1 and the series connection region MG described above. In the present example embodiment, as the measurement points, the measurement points M1 to M6 are set in the first capacitor portion CAP1 and the second capacitor portion CAP2 as the capacitor effective portions, and the series connection region MG including the coupling portion E0. The measurement points M1 to M3 are set adjacent to the first main surface TS1 in the inner layer portion 11, and the measurement points M4 to M6 are set adjacent to the second main surface TS2 in the inner layer portion 11.

The measurement points M1 and M4 are set in a region including the first counter portions EA of the first internal electrode layers 31 and the first electrode layer-side counter portions ECA of the intermediate electrode layers 33 in the first capacitor portion CAP1. The measurement point M1 is set adjacent to the first main surface TS1 in the inner layer portion 11, and the measurement point M4 is set adjacent to the second main surface TS2 in the inner layer portion 11.

The measurement points M2 and M5 are set in a region including the coupling portions E0 of the intermediate electrode layers 33 in the series connection region MG. The measurement point M2 is set adjacent to the first main surface TS1 in the inner layer portion 11, and the measurement point M5 is set adjacent to the second main surface TS2 in the inner layer portion 11.

The measurement points M3 and M6 are set in a region including the second counter portions EB of the second internal electrode layers 32 and the second electrode layer-side counter portions ECB of the intermediate electrode layers 33 in the second capacitor portion CAP2. The measurement point M3 is set adjacent to the first main surface TS1 in the inner layer portion 11, and the measurement point M6 is set adjacent to the second main surface TS2 in the inner layer portion 11.

In a case of multilayer ceramic capacitors each including three or more portions as in an example embodiment described later, the measurement points to be set are preferably set in a region depending on its configuration. However, they are set in the capacitor effective portion 11E1 and the series connection region MG in the same manner as in the present example embodiment.

In the exposed LT cross section, the undulation amount is measured using an optical microscope. The measurement of the undulation amount is performed at the above-described measurement points M1 to M6. The observation magnification at the time of observing each measurement point is 1000 times.

The undulation amount is calculated by the ratio (L1/L0) of the length L1 measured along the cross-sectional shape of the internal electrode layer 30 in a predetermined region to the linear distance L0 in the length direction L of the internal electrode layer 30 in a predetermined region based on the cross-sectional shape of the internal electrode layer 30 extracted from the optical microscope image. The length L1 can be obtained by measuring the length along the cross-sectional shape of the internal electrode layer including undulation using, for example, a multipoint mode of image analysis software.

For example, in the cross section of each measurement point, the undulation amount of each of six internal electrode layers 30 is calculated, and the average value thereof is calculated as the undulation amount at each measurement point. Then, the average values of the undulation amounts at the predetermined measurement points are calculated as the undulation amount of the intermediate electrode layer 33 in the series connection region MG and the undulation amounts of the first internal electrode layer 31, the second internal electrode layer 32, and the intermediate electrode layer 33 in the capacitor effective portion 11E1.

Specifically, when the undulation amount of the intermediate electrode layer 33 in the series connection region MG is measured, the undulation amounts of the intermediate electrode layers 33 in the series connection region MG are measured at the measurement points M2 and M5, and the average value thereof is calculated as the undulation amount of the intermediate electrode layer 33 in the series connection region MG. When the undulation amounts of the first internal electrode layer 31, the second internal electrode layer 32, and the intermediate electrode layer 33 in the capacitor effective portion 11E1 are measured, the undulation amounts of the electrode layers in the capacitor effective portion 11E1 are calculated at the measurement points M1, M3, M4, and M6, and the average value thereof is calculated as the undulation amounts of the first internal electrode layer 31, the second internal electrode layer 32, and the intermediate electrode layer 33 in the capacitor effective portion 11E1.

Next, a non-limiting of example a method of manufacturing the multilayer ceramic capacitor 1 of the present example embodiment will be described. The manufacturing method of the multilayer ceramic capacitor 1 of the present example embodiment is not limited as long as the requirements described above are satisfied. However, an example embodiment of a manufacturing method includes the following steps. The details of each step will be described below.

A dielectric sheet for manufacturing the dielectric layer 20 and an electrically conductive paste for manufacturing the internal electrode layer 30 are prepared. The dielectric sheet and the electrically conductive paste for manufacturing the internal electrode include a binder and a solvent. The binder and the solvent may be known.

An electrically conductive paste for manufacturing the internal electrode layer 30 is printed on the dielectric sheet in a predetermined pattern by, for example, screen printing or gravure printing. As a result, a dielectric sheet with a pattern of the first internal electrode layer 31, a dielectric sheet with a pattern of the second internal electrode layer 32, and a dielectric sheet with a pattern of the intermediate electrode layer 33 are prepared. The printing method is not limited to screen printing or the like.

By laminating a predetermined number of dielectric sheets on which the pattern of the internal electrode layer 30 is not printed, a portion functioning as the first main surface-side outer layer portion 12 adjacent to the first main surface TS1 is formed.

Next, the dielectric sheet subjected to screen printing is sequentially laminated on the surface of the portion functioning as the first main surface-side outer layer portion 12, such that the portion functioning as the inner layer portion 11 is formed.

Pressure is sequentially applied every time the screen-printed dielectric sheets are laminated. The dielectric sheet has a portion to which the conductive paste is applied and a portion to which the conductive paste is not applied, and therefore, the thickness of the dielectric sheet as a whole is not uniform. Therefore, when the dielectric sheet on which the pattern of the first internal electrode layer 31 and the pattern of the second internal electrode layer 32 are formed and the dielectric sheet on which the pattern of the intermediate electrode layer 33 is formed are overlapped with each other, a space corresponding to the thickness of the electrically conductive paste is generated between these two dielectric sheets in a region of either one of these two dielectric sheets where the electrically conductive paste is not applied. When pressure is applied to a portion of the region in the thickness direction, the dielectric sheet is distorted so as to fill the space. At this time, by laminating the dielectric sheets while applying pressure in a non-uniform manner, wrinkles are generated in the dielectric sheets.

A predetermined number of dielectric sheets on which the pattern of the internal electrode layer 30 is not printed are laminated on the surface of the portion functioning as the inner layer portion 11, such that a portion functioning as the second main surface-side outer layer portion 13 adjacent to the second main surface TS2 is formed. This produces a multilayer sheet.

The multilayer sheet is pressed in the height direction by isostatic pressing, for example, to produce a multilayer block. Here, since wrinkles generated at the time of lamination of the dielectric sheet are taken over to a certain degree even after pressure bonding by pressing, undulation of the element of each of the dielectric layers 20 can be generated.

The multilayer block is cut into multilayer chips of a predetermined size. In this case, the multilayer chips may be polished, for example, by barrel polishing, to round the corner portions and edge portions.

The multilayer chips are fired to produce the multilayer body 10. The firing temperature is preferably between about 900° C. and about 1400° C. inclusive, for example, depending on the materials of the dielectric layer 20 and the internal electrode layer 30.

An electrically conductive paste, which will function as the base electrode layers, is applied to both end surfaces of the multilayer body 10.

However, the above is one example of a manufacturing method, and the present invention is not limited thereto. The base electrode layer can also be adjusted by removal after the firing processing.

In the present example embodiment, the base electrode layer is a fired layer. The electrically conductive paste including glass components and metal is applied to the multilayer body 10, for example, by dipping. Subsequently, the base electrode layer is formed through firing processing. The firing temperature in this case is preferably between about 700° C. and about 900° C. inclusive, for example.

In the cases of simultaneously firing the pre-firing multilayer chip and the electrically conductive paste applied to the multilayer chips, the fired layer is preferably formed by firing a material including a ceramic material instead of glass components. In this case, as the ceramic material to be added, a ceramic material of the same type as the dielectric layer 20 is particularly preferably used. In this case, an electrically conductive paste is applied to the pre-firing multilayer chips, and the multilayer chips as well as the electrically conductive paste applied to the multilayer chips are simultaneously fired, thus forming the multilayer body 10 with the fired layers.

Subsequently, a plated layer is formed on the surface of the base electrode layers. In the present example embodiment, the first plated layer 60A is formed on the surface of the first base electrode layer 50A. The second plated layer 60B is formed on the surface of the second base electrode layer 50B. In the present example embodiment, a Ni plated layer and a Sn plated layer are formed as the plated layers. For the plating processing, either electrolytic plating or electroless plating may be used.

However, electroless plating requires pretreatment with catalysts to improve the plating deposition rate, involving a drawback to increase complexity of the steps. Therefore, electrolytic plating is preferred in most cases. The Ni plated layer and the Sn plated layer are sequentially formed, for example, by barrel plating.

The electrically conductive resin layer, when provided as the base electrode layer, may be provided to cover the fired layer. In the case of providing a electrically conductive resin layer, an electrically conductive resin paste including thermosetting resin and metal components is applied onto the fired layer, followed by heat treatment at temperature ranging from about 250° C. to about 550° C. or higher, for example. This processing causes the thermosetting resin to cure, forming the electrically conductive resin layer. The atmosphere during this heat treatment is preferably an N₂ environment. The oxygen concentration is preferably about 100 ppm or lower, for example, in order to prevent the resin from dispersing and prevent the various metal components from oxidating.

Through such manufacturing steps, the multilayer ceramic capacitor 1 is manufactured.

### Second Example Embodiment

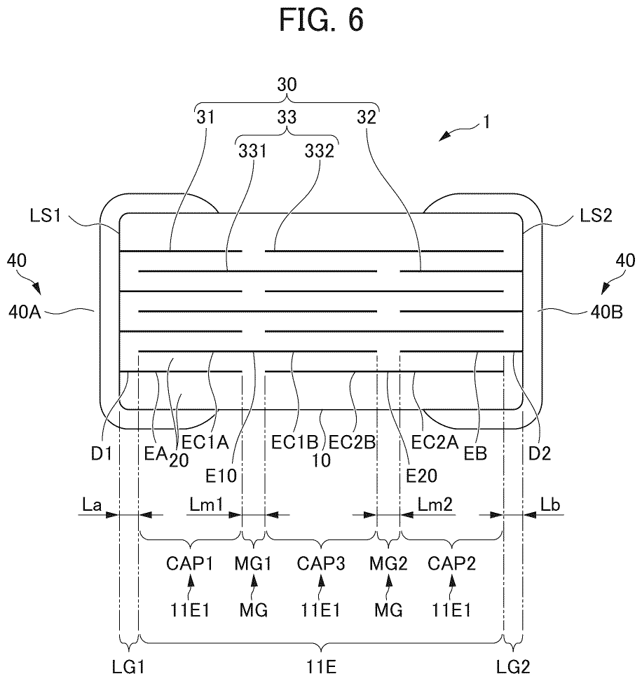

The multilayer ceramic capacitor 1 is not limited to the configuration shown in FIGS. 1 to 4B. For example, the multilayer ceramic capacitor 1 may be a multilayer ceramic capacitor having a three-portion configuration as shown in FIG. 6, and it is possible to obtain the advantageous effects of example embodiments of the present invention.

Hereinafter, a multilayer ceramic capacitor 1 according to a second example embodiment will be described with reference to FIG. 6. In the following description, detailed descriptions of the same configurations as those of the first example embodiment may be omitted. FIG. 6 is a schematic view for explaining a schematic configuration of a three-portion-configured multilayer ceramic capacitor according to a second example embodiment.

The multilayer ceramic capacitor 1 of the present example embodiment is different from that of the first example embodiment in the internal electrode layer 30 inside the multilayer body 10 and the external electrode 40. Specifically, in the multilayer ceramic capacitor 1 according to the first example embodiment, the internal electrode layer 30 has a two-portion configuration, whereas, in the multilayer ceramic capacitor 1 according to the second example embodiment, the internal electrode layer 30 has a three-portion configuration, and the configuration of the internal electrode layer 30 inside the multilayer body 10 is different from that of the first example embodiment.

The plurality of internal electrode layers 30 include the plurality of first internal electrode layers 31 functioning as the plurality of first electrically inner conductive layers, the plurality of second internal electrode layers 32 functioning as the plurality of second inner electrically conductive layers, and the intermediate electrode layer 33.

As shown in FIG. 6, the intermediate electrode layer 33 of the second example embodiment includes a first intermediate electrode layer 331 and a second intermediate electrode layer 332.

The first intermediate electrode layer 331 includes a first electrode layer-side counter portion EC1A, a first intermediate electrode layer counter portion EC1B, and a first coupling portion E10. The first electrode layer-side counter portion EC1A is a region opposed to the first internal electrode layer 31 adjacent in the lamination direction T, provided inside the multilayer body 10. The first intermediate electrode layer counter portion EC1B is a region opposed to the second intermediate electrode layer 332 adjacent in the lamination direction T, provided inside the multilayer body 10. The first coupling portion E10 is a portion connecting the first electrode layer-side counter portion EC1A and the first intermediate electrode layer counter portion EC1B with each other, and is provided between the first electrode layer-side counter portion EC1A and the first intermediate electrode layer counter portion EC1B.

The second intermediate electrode layer 332 includes a second electrode layer-side counter portion EC2A, a second intermediate electrode layer counter portion EC2B, and a second coupling portion E20. The second electrode layer-side counter portion EC2A is opposed to the second internal electrode layer 32 adjacent in the lamination direction T. The second intermediate electrode layer counter portion EC2B is opposed to the first intermediate electrode layer 331 adjacent in the lamination direction T. The second coupling portion E20 is a portion connecting the second electrode layer-side counter portion EC2A and the second intermediate electrode layer counter portion EC2B with each other, and is provided between the second electrode layer-side counter portion EC2A and the second intermediate electrode layer counter portion EC2B.

As shown in FIG. 6, in the multilayer ceramic capacitor 1 according to the second example embodiment, the first internal electrode layer 31 and the second intermediate electrode layer 332 are provided adjacent in the length direction L. In the multilayer ceramic capacitor 1 of the second example embodiment, the second internal electrode layer 32 and the first intermediate electrode layer 331 are provided adjacent in the length direction L. In the multilayer ceramic capacitor 1 of the second example embodiment, the first internal electrode layer 31 and the second intermediate electrode layer 332 are laminated alternately to overlap the second internal electrode layer 32 and the first intermediate electrode layer 331, interposing the dielectric layers 20.

In the present example embodiment, the first counter portion EA and the first electrode layer-side counter portion EC1A are opposed to each other, interposing the dielectric layer 20, such that the capacitance CAP1 (first capacitor portion CAP1) is generated. The second counter portion EB and the second electrode layer-side counter portion EC2A are opposed to each other, interposing the dielectric layer, such that the capacitance CAP2 (second capacitor portion CAP2) is generated. The first intermediate electrode layer counter portion EC1B and the second intermediate electrode layer counter portion EC2B are opposed to each other, interposing the dielectric layer 20, such that the capacitance CAP3 (third capacitor portion CAP3) is generated. The first coupling portion E10 connects the capacitance CAP1 and the capacitance CAP3 in series. The second coupling portion E20 connects the capacitance CAP2 and the capacitance CAP3 in series. The multilayer ceramic capacitor 1 of the present example embodiment is a three-portion-configured, i.e., series-configured multilayer ceramic capacitor 1, in which three capacitor portions are connected in series.

The multilayer body 10 includes a series capacitor defining portion 11E. The series capacitor defining portion 11E includes a portion generating the capacitance CAP1, a portion generating the capacitance CAP2, a portion generating the capacitance CAP3, a portion serially connecting the capacitances CAP1 and CAP3, and a portion connecting the capacitances CAP2 and CAP3 in series. The series capacitor defining portion 11E is a portion of the inner layer portion 11. In the series capacitor defining portion 11E, the portion generating the capacitance CAP1 (first capacitor portion CAP1), the portion generating the capacitance CAP2 (second capacitor portion CAP2), and the portion generating the capacitance CAP3 (third capacitor portion CAP3) are also referred to as the capacitor effective portions.

The series capacitor defining portion 11E of the multilayer body 10 includes series connection regions MG. The series connection regions MG include a first series connection region MG1 as s a first intermediate gap and a second series connection region MG2 as a second intermediate gap. The first series connection region MG1 is a portion which includes the dielectric layer 20 and the first coupling portion E10 and is located between the portion generating the capacitance CAP1 and the portion generating the capacitance CAP3. The second series connection region MG2 is a portion which includes the dielectric layer 20 and the second coupling portion E20 and is located between the portion generating the capacitance CAP2 and the portion generating the capacitance CAP3. Thus, the first series connection region MG1 is a collective portion including part of the plurality of dielectric layers 20 overlapping the first coupling portion E10 as viewed from the lamination direction T, and the plurality of first coupling portions E10. The second series connection region MG2 is a collective portion including portions of the plurality of dielectric layers 20 overlapping the second coupling portion E20 as viewed from the lamination direction T, and the plurality of second coupling portions E20.

As shown in FIG. 6, the external electrodes 40 include the first external electrode 40A adjacent to the first end surface LS1 of the multilayer body 10, and the second external electrode 40B adjacent to the second end surface LS2 of the multilayer body 10.

The first coupling portion E10 connects the capacitance CAP1 and the capacitance CAP3 in series. The second coupling portion E20 connects the capacitance CAP2 and the capacitance CAP3 in series. Therefore, capacitor characteristics of the series-connected capacitance manifest between the first external electrode 40A connected to the first internal electrode layer 31 and the second external electrode 40B connected to the second internal electrode layer 32.

In the multilayer ceramic capacitor 1 according to the second example embodiment, the undulation amounts of the intermediate electrode layer 33 in the first series connection region MG1 and the second series connection region MG2 are larger than the undulation amounts of the first internal electrode layer 31, the second internal electrode layer 32, and the intermediate electrode layer 33 in the capacitor effective portion 11E1.

For example, the undulation amount of the first intermediate electrode layer 331 in the first series connection region MG1 is preferably about 100.1% or more and about 100.8% or less, for example. The undulation amount of the second intermediate electrode layer 332 in the second series connection region MG2 is preferably about 100.1% or more and about 100.8% or less, for example.

Further, the undulation amounts of the first internal electrode layer 31, the second internal electrode layer 32, and the first intermediate electrode layer 331 and the second intermediate electrode layer 332 of the intermediate electrode layer 33 in the capacitor effective portion 11E1 are preferably greater than about 100.0% and less than or equal to about 100.5%, for example.

The distance Lm1 in the length direction L of the first series connection region MG1 may be longer than the distance La in the length direction L of the first end surface-side outer layer portion LG1 and the distance Lb in the length direction L of the second end surface-side outer layer portion LG2. The distance Lm2 in the length direction L of the second series connection region MG2 may be longer than the distance La in the length direction L of the first end surface-side outer layer portion LG1 and the distance Lb in the length direction L of the second end surface-side outer layer portion LG2.

Also in the multilayer ceramic capacitor 1 according to the second example embodiment, it is possible to reduce or prevent the influence of strain due to the electrostrictive effect in the dielectric layer 20 as a whole, and it is possible to obtain an advantageous effect of reducing or preventing cracks and acoustic noise due to electrostriction.

### Third Example Embodiment

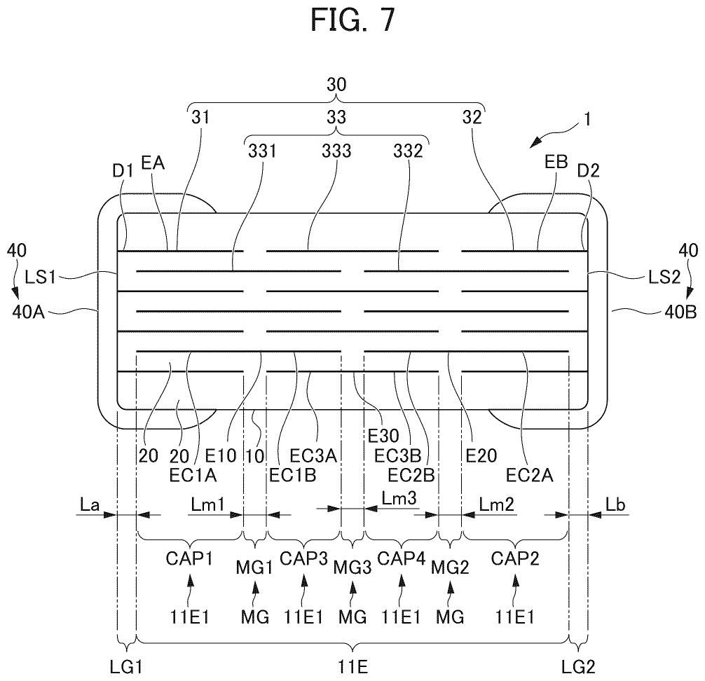

The multilayer ceramic capacitor 1 is not limited to the configuration shown in FIGS. 1 to 4B. For example, the multilayer ceramic capacitor 1 may be a four-portion-configured multilayer ceramic capacitor as shown in FIG. 7, and it is possible to obtain the advantageous effects of example embodiments of the present invention.

Hereinafter, a multilayer ceramic capacitor 1 according to a third example embodiment will be described with reference to FIG. 7. In the following description, detailed descriptions of the same configurations as those of the first example embodiment will be omitted. FIG. 7 is a schematic view for explaining a schematic configuration of a four-portion-configured multilayer ceramic capacitor according to a third example embodiment.

In the multilayer ceramic capacitor 1 of the present example embodiment, the internal electrode layers 30 inside the multilayer body 10 and the external electrodes 40 differs from that of the first example embodiment. Specifically, while the multilayer ceramic capacitor 1 of the first example embodiment includes the two-portion configuration of the internal electrode layers 30, the multilayer ceramic capacitor 1 of the third example embodiment includes a four-portion configuration of the internal electrode layers 30, and the internal electrode layers 30 inside the multilayer body 10 differs from that of the first example embodiment.

The plurality of internal electrode layers 30 include the plurality of first internal electrode layers 31 as the plurality of first inner electrically conductive layers, the plurality of second internal electrode layers 32 as the plurality of second inner electrically conductive layers, and the intermediate electrode layer 33.

As shown in FIG. 7, the intermediate electrode layer 33 includes a first intermediate electrode layer 331, a second intermediate electrode layer 332, and a third intermediate electrode layer 333.

The first intermediate electrode layer 331 includes the first electrode layer-side counter portion EC1A opposed to the first internal electrode layer 31 adjacent in the lamination direction T, the first intermediate electrode layer counter portion EC1B opposed to the third intermediate electrode layer 333 adjacent in the lamination direction T, and the first coupling portion E10.

The second intermediate electrode layer 332 includes the second electrode layer-side counter portion EC2A opposed to the second internal electrode layer 32 adjacent in the lamination direction T, the second intermediate electrode layer counter portion EC2B opposed to the third intermediate electrode layer 333 adjacent in the lamination direction T, and the second coupling portion E20.

The third intermediate electrode layer 333 includes the third intermediate electrode layer counter portion EC3A opposed to the first intermediate electrode layer 331 adjacent in the lamination direction T, the fourth intermediate electrode layer counter portion EC3B opposed to the second intermediate electrode layer 332 adjacent in the lamination direction T, and the third coupling portion E30.

As shown in FIG. 7, in the multilayer ceramic capacitor 1 according to the third example embodiment, the first internal electrode layer 31, the third intermediate electrode layer 333, and the second internal electrode layer 32 are provided adjacent in the length direction L. In the multilayer ceramic capacitor 1 according to the third example embodiment, the first intermediate electrode layer 331 and the second intermediate electrode layer 332 are provided adjacent in the length direction L.

In the multilayer ceramic capacitor 1 according to the third example embodiment, the first internal electrode layer 31, the third intermediate electrode layer 333, and the second internal electrode layer 32 are laminated alternately to overlap the first intermediate electrode layer 331 and the second intermediate electrode layer 332, interposing the dielectric layers 20.

In the present example embodiment, the first counter portion EA and the first electrode layer-side counter portion EC1A are opposed to each other, interposing the dielectric layer 20, such that the capacitance CAP1 (first capacitor portion CAP1) is generated. The second counter portion EB and the second electrode layer-side counter portion EC2A are opposed to each other, interposing the dielectric layer 20, such that the capacitance CAP2 (second capacitor portion CAP2) is generated. The first intermediate electrode layer counter portion EC1B and the third intermediate electrode layer counter portion EC3A are opposed to each other, interposing the dielectric layer 20, such that the capacitance CAP3 (third capacitor portion CAP3) is generated. The second intermediate electrode layer counter portion EC2B and the fourth intermediate electrode layer counter portion EC3B are opposed to each other, interposing the dielectric layer 20, such that the capacitance CAP4 (fourth capacitor portion CAP4) is generated. The first coupling portion E10 connects the capacitance CAP1 and the capacitance CAP3 in series. The second coupling portion E20 connects the capacitance CAP2 and the capacitance CAP4 in series. The third coupling portion the E30 connects capacitance CAP3 and the capacitance CAP4 in series. The multilayer ceramic capacitor 1 of the present example embodiment is a four-portion-configured series-configured multilayer ceramic capacitor 1, in which four capacitor portions are connected in series.

The multilayer body 10 includes the series capacitor defining portion 11E. The series capacitor defining portion 11E is configured as a portion of the inner layer portion 11. In the series capacitor defining portion 11E, a portion (first capacitor portion CAP1) generating the capacitance CAP1, a portion (second capacitor portion CAP2) generating the capacitance CAP2, a portion (third capacitor portion CAP3) generating the capacitance CAP3, and a portion (fourth capacitor portion CAP4) generating the capacitance CAP4 are also referred to as a capacitor effective portion.

The series capacitor defining portion 11E of the multilayer body 10 includes series connection regions MG. The series connection regions MG include a first series connection region MG1 as a first intermediate gap, a second series connection region MG2 as a second intermediate gap, and a third series connection region MG3 as a third intermediate gap. The first series connection region MG1 is a portion which includes the dielectric layer 20 and the first coupling portion E10 and is located between the portion generating the capacitance CAP1 and the portion generating the capacitance CAP3. The second series connection region MG2 is a portion which includes the dielectric layer 20 and the second coupling portion E20 and is located between the portion generating the capacitance CAP2 and the portion generating the capacitance CAP4. The third series connection region MG3 is a portion which includes the dielectric layer 20 and the third coupling portion E30 and is located between the portion generating the capacitance CAP3 and the portion generating the capacitance CAP4.

Thus, the first series connection region MG1 is a collective portion including the plurality of dielectric layers 20 overlapping the first coupling portion E10 as viewed from the lamination direction T, and the plurality of first coupling portions E10. The second series connection region MG2 is a collective portion including the plurality of dielectric layers 20 overlapping the second coupling portion E20 as viewed from the lamination direction T, and the plurality of second coupling portions E20. The third series connection region MG3 is a collective portion including the plurality of dielectric layers 20 overlapping the third coupling portion E30 as viewed from the lamination direction T, and the plurality of third coupling portions E30.

As shown in FIG. 7, the external electrodes 40 include the first external electrode 40A adjacent to the first end surface LS1 of the multilayer body 10, and the second external electrode 40B adjacent to the second end surface LS2 of the multilayer body 10.

The first coupling portion E10 connects the capacitance CAP1 and the capacitance CAP3 in series. The second coupling portion E20 connects the capacitance CAP2 and the capacitance CAP4 in series. The third coupling portion E30 connects the capacitance CAP3 and the capacitance CAP4 in series. Therefore, capacitor characteristics of the series-connected capacitance manifest between the first external electrode 40A connected to the first internal electrode layer 31 and the second external electrode 40B connected to the second internal electrode layer 32.

In the multilayer ceramic capacitor 1 according to the third example embodiment, the undulation amounts of the intermediate electrode layers 33 in the first series connection region MG1, the second series connection region MG2, and the third series connection region MG3 are larger than the undulation amounts of the first internal electrode layer 31, the second internal electrode layer 32, and the intermediate electrode layer 33 in the capacitor effective portion 11E1.

For example, the undulation amount of the first intermediate electrode layer 331 in the first series connection region MG1 may be about 100.1% or more and about 100.8% or less, for example. The undulation amount of the second intermediate electrode layer 332 in the second series connection region MG2 may be about 100.1% or more and about 100.8% or less, for example. The undulation amount of the third intermediate electrode layer 333 in the third series connection region MG3 may be about 100.1% or more and about 100.8% or less, for example.

The undulation amounts of the first internal electrode layer 31, the second internal electrode layer 32, and the first intermediate electrode layer 331, the second intermediate electrode layer 332, and the third intermediate electrode layer 333 of the intermediate electrode layer 33 in the capacitor effective portion 11E1 may be greater than about 100.0% and less than or equal to about 100.5%, for example.

Further, the distance Lm1 in the length direction L of the first series connection region MG1 may be longer than the distance La in the length direction L of the first end surface-side outer layer portion LG1 and the distance Lb in the length direction L of the second end surface-side outer layer portion LG2. The distance Lm2 in the length direction L of the second series connection region MG2 may be longer than the distance La in the length direction L of the first end surface-side outer layer portion LG1 and the distance Lb in the length direction L of the second end surface-side outer layer portion LG2. The distance Lm3 in the length direction L of the third series connection region MG3 may be longer than the distance La in the length direction L of the first end surface-side outer layer portion LG1 and the distance Lb in the length direction L of the second end surface-side outer layer portion LG2.

Also in the multilayer ceramic capacitor 1 according to the third example embodiment, it is possible to reduce or prevent the influence of strain due to the electrostrictive effect in the dielectric layer 20 as a whole, and it is possible to obtain an advantageous effect of reducing or preventing cracks and acoustic noise due to electrostriction.

The multilayer ceramic capacitors according to the example embodiments described above have the following advantageous effects. In each of the typical multilayer ceramic capacitors, the external electrodes 40 are respectively provided on the end surfaces of the multilayer body 10 in which the dielectric layers 20 and the internal electrode layers 30 are alternately laminated. In particular, in multilayer ceramic capacitors in the middle-high voltage region, a series configuration is adopted in which the intermediate electrode layers 33 not exposed at the end surface are introduced in addition to the internal electrode layers 30 exposed at the end surface, and the voltage applied to the dielectric layer 20 functioning as the element is dispersed to improve the voltage resistance.

However, it is generally known that a high permittivity material is used for the dielectric layer 20 in a multilayer ceramic capacitor, and an electrostrictive effect is generated that causes deformation in which the dielectric layer 20 expands in the electric field direction and contracts in a direction perpendicular to the electric field direction. When the inverse piezoelectric effect is generated, a crack parallel to the dielectric layer 20 is generated in the vicinity of the middle in the lamination direction T due to the inability to withstand the expanding stress, and the mounting substrate vibrates due to repeated expansion and contraction by the application of the DC voltage, and acoustic noise is generated. Further, it has been found that the stress becomes higher as the number of laminated elements increases, that is, as the number of the internal electrode layers 30 increases, which becomes a barrier to the multilayer formation.

In particular, in multilayer ceramic capacitors in a middle-high voltage region, a series configuration is used in order to disperse a voltage applied to one element. However, in order to lower the voltage applied to one element without changing the capacitance, it is necessary to increase the number of laminated layers according to the number of the series configuration. Therefore, in the series configuration, since it is necessary to increase the number of laminated layers as compared with the normal configuration, the generated stress becomes large, and crack generation and acoustic noise become remarkable.

According to example embodiments of the present disclosure, when a voltage is applied to the multilayer ceramic capacitor 1, which is a multilayer chip, it is possible to reduce or prevent electric field concentration in the entire multilayer chip by shifting the local electric field direction, and it is possible to reduce or prevent electrostriction and acoustic noise.

A multilayer ceramic capacitor according to an example embodiment includes the multilayer body 10 including the plurality of laminated dielectric layers 20 and the plurality of laminated internal electrode layers 30. The multilayer body 10 includes the first main surface TS1 and the second main surface TS2 opposed to each other in the lamination direction T, the first lateral surface WS1 and the second lateral surface WS2 opposed to each other in the width direction W orthogonal or substantially orthogonal to the lamination direction T, and the first end surface LS1 and the second end surface LS2 opposed to each other in the length direction L orthogonal or substantially orthogonal to the lamination direction and the width direction, the first external electrode 40A on the first end surface LS1, and the second external electrode 40B on the second end surface LS2. The plurality of internal electrode layers 30 include the first internal electrode layers 31, the second internal electrode layers 32, and the intermediate electrode layers 33. Each of the first internal electrode layers 31 includes the first extension portion D1 at one end thereof that extends toward the first end surface LS1 and is connected to the first external electrode 40A, and the first counter portion EA that is connected to the first extension portion D1 and is opposed to at least one corresponding internal electrode layer 30 adjacent in the lamination direction T. Each of the second internal electrode layers 32 includes the second extension portion D2 at one other end thereof that extends toward the second end surface LS2 and is connected to the second external electrode 40B, and the second counter portion EB that is connected to the second extension portion D2 and is opposed to at least one corresponding internal electrode layer 30 adjacent in the lamination direction T. Each of the intermediate electrode layers 33 as the internal electrode layers 30 is not connected to the first external electrode 40A or the second external electrode 40B, and defines a series connection capacitor together with a corresponding one of the first internal electrode layers 31 and a corresponding one of the second internal electrode layers 32. The multilayer body 10 includes the inner layer portion 11 including the plurality of dielectric layers 20 and the plurality of internal electrode layers 30 alternately laminated, the first lateral surface-side outer layer portion WG1 that is provided adjacent to the first lateral surface WS1 and includes only at least one of the plurality of dielectric layers 20 laminated, and the second lateral surface-side outer layer portion WG2 that is provided adjacent to the second lateral surface WS2 and includes only at least one of the plurality of dielectric layers 20 laminated. The inner layer portion 11 includes the capacitor effective portion 11E1 (the effective layer portion 11E1) in which two layers among the first internal electrode layers 31, the second internal electrode layers 32, and the intermediate electrode layers 33 are laminated alternately with a corresponding one of the plurality of dielectric layers 20 interposed therebetween, the first end surface-side outer layer portion LG1 that is provided adjacent to the first end surface LS1 and includes the plurality of dielectric layers 20 and the plurality of first internal electrode layers 31 alternately laminated, the second end surface-side outer layer portion LG2 that is provided adjacent to the second end surface LS2 and includes the plurality of dielectric layers 20 and the plurality of second internal electrode layers 32 alternately laminated, and the series connection region MG (the intermediate gap MG) including the plurality of dielectric layers 20 and the intermediate electrode layers 33 alternately laminated. In a cross section parallel to the length direction L and the lamination direction T, when the ratio (L1/L0) of the length (L1) measured along a cross-sectional shape of an internal electrode layer 30 in a predetermined region to the linear distance (L0) in a length direction L of an internal electrode layer 30 in a predetermined region is defined as an undulation amount, the undulation amount of a corresponding one of the intermediate electrode layers 33 in the series connection region MG is larger than the undulation amount of each of a corresponding one of the first internal electrode layers 31, a corresponding one of the second internal electrode layers 32, and a corresponding one of the intermediate electrode layers 33 in the effective layer portion 11E1.

With such a configuration, also in the multilayer ceramic capacitor 1 with the high breakdown voltage specification, it is possible to provide the multilayer ceramic capacitor 1 that is able to reduce or prevent the occurrence of cracks and acoustic noise due to the electrostrictive effect.

In a multilayer ceramic capacitor according to an example embodiment, the undulation amount of a corresponding one of the intermediate electrode layers 33 in the series connection region MG is about 100.1% or more and about 100.8% or less, for example.

With such a configuration, it is possible to provide the multilayer ceramic capacitor 1 that is able to reduce or prevent the occurrence of cracks and acoustic noise due to the electrostrictive effect, while reducing or preventing the decrease in insulation resistance even in the multilayer ceramic capacitor 1 with the high breakdown voltage specification.

Further, in a multilayer ceramic capacitor according to an example embodiment, the undulation amount of each of a corresponding one of the first internal electrode layers 31, a corresponding one of the second internal electrode layers 32, and a corresponding one of the intermediate electrode layers 33 in the capacitor effective portion 11E1 is about 100.5% or less.

With such a configuration, it is possible to provide the multilayer ceramic capacitor 1 that is able to reduce or prevent the occurrence of cracks and acoustic noise due to the electrostrictive effect, while reducing or preventing the decrease in insulation resistance even in the multilayer ceramic capacitor 1 with the high breakdown voltage specification.

In a multilayer ceramic capacitor according to an example embodiment, the distance Lm of the series connection region MG in the length direction L is longer than the distance La in the length direction L of the first extension portion D1 or the distance Lb in the length direction L of the second extension portion D2.

With such a configuration, also in the multilayer ceramic capacitor 1 with the high breakdown voltage specification, it is possible to provide the multilayer ceramic capacitor 1 that is able to reduce or prevent the occurrence of cracks and acoustic noise due to the electrostrictive effect.

In a multilayer ceramic capacitor according to an example embodiment, the intermediate electrode layers 33 include the first intermediate electrode layers 331 and the second intermediate electrode layers the 332, first intermediate electrode layers 331 each include the first electrode layer-side counter portion EC1A that is opposed to at least one corresponding first internal electrode layer 31 provided adjacent in the lamination direction T, and the first intermediate electrode layer counter portion EC1B that is opposed to at least one corresponding second intermediate electrode layer 332 provided adjacent in the lamination direction T, the second intermediate electrode layers 332 each include the second electrode layer-side counter portion EC2A that is opposed to at least one corresponding second internal electrode layer 32 provided adjacent in the lamination direction T, and the second intermediate electrode layer counter portion EC2B that is opposed to at least one corresponding first intermediate electrode layer 331 provided adjacent in the lamination direction T, the series connection region MG includes the first series connection region MG1 provided between the first internal electrode layers 31 and the second intermediate electrode layers 332, and the second series connection region MG2 provided between the second internal electrode layers 32 and the first intermediate electrode layers 331, and the undulation amount of each of the intermediate electrode layers 33 in the first series connection region MG1 and the second series connection region MG2 is larger than the undulation amount of each of a corresponding one of the first internal electrode layers 31, a corresponding one of the second internal electrode layers 32, and a corresponding one of the intermediate electrode layers 33 in the capacitor effective portion 11E1.

With such a configuration, also in the three-portion configured multilayer ceramic capacitor 1 with the high breakdown voltage specification, it is possible to provide the multilayer ceramic capacitor 1 that is able to reduce or prevent the occurrence of cracks and acoustic noise due to the electrostrictive effect.

In a multilayer ceramic capacitor according to an example embodiment, the intermediate electrode layers 33 include the first intermediate electrode layers 331, the second intermediate electrode layers 332, and the third intermediate electrode layers 333, the first intermediate electrode layers 331 each include the first electrode layer-side counter portion EC1A that is opposed to at least one corresponding first internal electrode layer 31 provided adjacent in the lamination direction T, and the first intermediate electrode layer counter portion EC1B that is opposed to at least one corresponding third intermediate electrode layer 333 provided adjacent in the lamination direction T, the second intermediate electrode layers 332 each include the second electrode layer-side counter portion EC2A that is opposed to at least one corresponding second internal electrode layer 32 provided adjacent in the lamination direction T, and the second intermediate electrode layer counter portion EC2B that is opposed to at least one corresponding third intermediate electrode layer 333 provided adjacent in the lamination direction T, the third intermediate electrode layers 333 each include the third intermediate electrode layer counter portion EC3A that is opposed to at least one corresponding first intermediate electrode layer 331 provided adjacent in the lamination direction T, and the fourth intermediate electrode layer counter portion EC3B that is opposed to at least one corresponding second intermediate electrode layer 332 provided adjacent in the lamination direction T, the series connection region MG includes the first series connection region MG1 provided between the first internal electrode layers 31 and the third intermediate electrode layers 333, the second series connection region MG2 provided between the second internal electrode layers 32 and the third intermediate electrode layers 333, and the third series connection region MG3 provided between the first intermediate electrode layers 331 and the second intermediate electrode layers 332, and the undulation amount of each of the intermediate electrode layers 33 in the first series connection region MG1, the second series connection region MG2, and the third series connection region MG3 is larger than the undulation amount of each of a corresponding one of the first internal electrode layers 31, a corresponding one of the second internal electrode layers 32, and a corresponding one of the intermediate electrode layers 33 in the capacitor effective portion 11E1.

With such a configuration, also in the four-portion-configured multilayer ceramic capacitor 1 with a high breakdown voltage specification, it is possible to provide the multilayer ceramic capacitor 1 that is able to reduce or prevent the occurrence of cracks and acoustic noise due to the electrostrictive effect.

The present invention is not limited to the configurations of the above-described example embodiments, and can be appropriately modified and applied without changing the gist of the present invention. In addition, a combination of two or more of the individual desirable configurations described in the above example embodiments is also included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of laminated dielectric layers and a plurality of laminated internal electrode layers, the multilayer body including a first main surface and a second main surface opposed to each other in a lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction;
a first external electrode on the first end surface; and
a second external electrode on the second end surface; wherein
the plurality of internal electrode layers include first internal electrode layers, second internal electrode layers, and intermediate electrode layers;
each of the first internal electrode layers includes a first extension portion at one end thereof that extends toward the first end surface and is connected to the first external electrode, and a first counter portion that is connected to the first extension portion and is opposed to at least one corresponding internal electrode layer adjacent in the lamination direction;
each of the second internal electrode layers includes a second extension portion at one other end thereof that extends toward the second end surface and is connected to the second external electrode, and a second counter portion that is connected to the second extension portion and is opposed to at least one corresponding internal electrode layer adjacent in the lamination direction;
each of the intermediate electrode layers is not connected to the first external electrode or the second external electrode, and defines a series connection capacitor together with a corresponding one of the first internal electrode layers and a corresponding one of the second internal electrode layers;
the multilayer body includes an inner layer portion including the plurality of dielectric layers and the plurality of internal electrode layers alternately laminated therein, a first lateral surface-side outer layer portion that is provided adjacent to the first lateral surface and includes only at least one of the plurality of dielectric layers laminated, and a second lateral surface-side outer layer portion that is provided adjacent to the second lateral surface and includes only at least one of the plurality of dielectric layers laminated;
the inner layer portion includes:
an effective layer portion in which two layers among the first internal electrode layers, the second internal electrode layers, and the intermediate electrode layers are laminated alternately with a corresponding one of the plurality of dielectric layers interposed therebetween;
a first end surface-side outer layer portion that is provided adjacent to the first end surface and includes the plurality of dielectric layers and the plurality of first internal electrode layers alternately laminated therein;
a second end surface-side outer layer portion that is provided adjacent to the second end surface and includes the plurality of dielectric layers and the plurality of second internal electrode layers alternately laminated therein; and
an intermediate gap including the plurality of dielectric layers and intermediate electrode layers alternately laminated therein;
in a cross section parallel to the length direction and the lamination direction, when a ratio (L1/L0) of a length (L1) measured along a cross-sectional shape of an internal electrode layer in a predetermined region to a linear distance (L0) in a length direction of an internal electrode layer in a predetermined region is defined as an undulation amount, an undulation amount of a corresponding one of the intermediate electrode layers in the intermediate gap is larger than an undulation amount of each of a corresponding one of the first internal electrode layers, a corresponding one of the second internal electrode layers, and a corresponding one of the intermediate electrode layers in the effective layer portion.

2. The multilayer ceramic capacitor according to claim 1, wherein the undulation amount of a corresponding one of the intermediate electrode layers in the intermediate gap is about 100.1% or more and about 100.8% or less.

3. The multilayer ceramic capacitor according to claim 1, wherein the undulation amount of each of a corresponding one of the first internal electrode layers, a corresponding one of the second internal electrode layers, and a corresponding one of the intermediate electrode layers in the effective layer portion is about 100.5% or less.

4. The multilayer ceramic capacitor according to claim 1, wherein a distance of the intermediate gap in the length direction is longer than a distance of the first extension portion or the second extension portion in the length direction.

5. The multilayer ceramic capacitor according to claim 1, wherein
the intermediate electrode layers includes first intermediate electrode layers and second intermediate electrode layers;
the first intermediate electrode layers each include a first electrode layer-side counter portion that is opposed to at least one corresponding first internal electrode layer provided adjacent in the lamination direction, and a first intermediate electrode layer counter portion that is opposed to at least one corresponding second intermediate electrode layer provided adjacent in the lamination direction;
the second intermediate electrode layers each include a second electrode layer-side counter portion that is opposed to at least one corresponding second internal electrode layer provided adjacent in the lamination direction, and a second intermediate electrode layer counter portion that is opposed to at least one corresponding first intermediate electrode layer provided adjacent in the lamination direction;
the intermediate gap includes a first intermediate gap provided between the first internal electrode layers and the second intermediate electrode layers, and a second intermediate gap provided between the second internal electrode layers and the first intermediate electrode layers; and
an undulation amount of each of the intermediate electrode layers in the first intermediate gap and the second intermediate gap is larger than an undulation amount of each of a corresponding one of the first internal electrode layers, a corresponding one of the second internal electrode layers, and a corresponding one of the intermediate electrode layers in the effective layer portion.

6. The multilayer ceramic capacitor according to claim 1, wherein
the intermediate electrode layers includes first intermediate electrode layers, second intermediate electrode layers, and third intermediate electrode layers;
the first intermediate electrode layers each include a first electrode layer-side counter portion that is opposed to at least one corresponding first internal electrode layer provided adjacent in the lamination direction, and a first intermediate electrode layer counter portion that is opposed to at least one corresponding third intermediate electrode layer provided adjacent in the lamination direction;
the second intermediate electrode layers each include a second electrode layer-side counter portion that is opposed to at least one corresponding second internal electrode layer provided adjacent in the lamination direction, and a second intermediate electrode layer counter portion that is opposed to at least one corresponding third intermediate electrode layer provided adjacent in the lamination direction;
the third intermediate electrode layers each include a third intermediate electrode layer counter portion that is opposed to at least one corresponding first intermediate electrode layer provided adjacent in the lamination direction, and a fourth intermediate electrode layer that is opposed to at least one corresponding second intermediate electrode layer provided adjacent in the lamination direction;
the intermediate gap includes a first intermediate gap provided between the first internal electrode layers and the third intermediate electrode layers, a second intermediate gap provided between the second internal electrode layers and the third intermediate electrode layers, and a third intermediate gap provided between the first intermediate electrode layers and the second intermediate electrode layers; and
an undulation amount of each of the intermediate electrode layers in the first intermediate gap, the second intermediate gap, and the third intermediate gap is larger than an undulation amount of each of a corresponding one of the first internal electrode layers, a corresponding one of the second internal electrode layers, and a corresponding one of the intermediate electrode layers in the effective layer portion.

7. The multilayer ceramic capacitor according to claim 1, wherein the multilayer body has a substantially rectangular parallelepiped shape.

8. The multilayer ceramic capacitor according to claim 1, wherein the multilayer body includes corners and edges that are rounded.

9. The multilayer ceramic capacitor according to claim 1, wherein an end portion adjacent to a first end surface of one of the intermediate electrode layers is spaced apart from the first end surface.

10. The multilayer ceramic capacitor according to claim 1, wherein an end portion adjacent to a first end surface of one of the intermediate electrode layers is provided adjacent to the first end surface farther than an end portion of the first external electrode.

11. The multilayer ceramic capacitor according to claim 1, wherein an end portion adjacent to a first end surface of one of the intermediate electrode layers is provided adjacent to the second end surface farther than an end portion of the first external electrode.

12. The multilayer ceramic capacitor according to claim 1, wherein an end portion adjacent to a second end surface of one of the intermediate electrode layers is spaced apart from the second end surface.

13. The multilayer ceramic capacitor according to claim 1, wherein the multilayer body includes a series connection region in which a portion of one of the internal electrode layers has a larger undulation amount than another of the internal electrode layers in a capacitor effective portion.

14. The multilayer ceramic capacitor according to claim 13, wherein a distance in the length direction of the series connection region is longer than a distance in the length direction of the first end surface-side outer layer portion and a distance in the length direction of the second end surface-side outer layer portion.

15. The multilayer ceramic capacitor according to claim 1, wherein each of the internal electrode layers has a two-portion configuration in which two capacitor portions are connected in series.

16. The multilayer ceramic capacitor according to claim 1, wherein each of the internal electrode layers has a three-portion configuration in which three capacitor portions are connected in series.

17. The multilayer ceramic capacitor according to claim 1, wherein each of the internal electrode layers has a four-portion configuration in which four capacitor portions are connected in series.

18. The multilayer ceramic capacitor according to claim 1, wherein the multilayer ceramic capacitor is a multilayer chip.

19. The multilayer ceramic capacitor according to claim 1, wherein each of the first and second external electrodes includes a base electrode layer and a plated layer.

20. The multilayer ceramic capacitor according to claim 19, wherein the plated layer includes a plurality of plated layers.
